SEQUENCE LISTING (19 sequences)

SEQ ID NO: 1 - protein, 37 aa, Hadronyche versuta
SPTCIPSGQPCPYNENCCSQSCTFKENENGNTVKRCD

SEQ ID NO: 2 - protein, 41 aa, Hadronyche versuta
GSQYCVPVDQPCSLNTQPCCDDATCTQERNENGHTVYYCRA

SEQ ID NO: 3 - protein, 39 aa, Hadronyche versuta
QYCVPVDQPCSLNTQPCCDDATCTQELNENDNTVYYCRA

SEQ ID NO: 4 - protein, 13 aa, synthetic construct
GGGGGGSAAAAAA

SEQ ID NO: 5 - protein, 5 aa, synthetic construct
  REPEAT 1..5: note = The entire sequence of amino acids 1-5 may be repeated up to six times.
GGGGS

SEQ ID NO: 6 - protein, 162 aa, synthetic construct
GSQYCVPVDQPCSLNTQPCCDDATCTQERNENGHTVYYCRAGGGGSAAADNILYSGETLSTGEFLNYGSFVFIMQEDCNLVLYDVDKPIWATNTGGLSRSCFLSMQTDGNLVVYNPSNKPIWASNTGGQNGNYVCILQKDRNVVIYGTDRWATGVDHHHHHH

SEQ ID NO: 7 - protein, 159 aa, synthetic construct
HHHHHHDNILYSGETLSTGEFLNYGSFVFIMQEDCNLVLYDVDKPIWATNTGGLSRSCFLSMQTDGNLVVYNPSNKPIWASNTGGQNGNYVCILQKDRNVVIYGTDRWATGGGGSAAAGSQYCVPVDQPCSLNTQPCCDDATCTQERNENGHTVYYCRA

SEQ ID NO: 8 - protein, 153 aa, synthetic construct
SPTCIPSGQPCPYNENCCSQSCTFKENENGNTVKRCDAAADNILYSGETLSTGEFLNYGSFVFIMQEDCNLVLYDVDKPIWATNTGGLSRSCFLSMQTDGNLVVYNPSNKPIWASNTGGQNGNYVCILQKDRNVVIYGTDRWATGVDHHHHHH

SEQ ID NO: 9 - protein, 146 aa, synthetic construct
ASPTCIPSGQPCPYNENCCSQSCTFKENENGNTVQRCDAAADNILYSGETLSTGEFLNYGSFVFIMQEDCNLVLYDVDKPIWATNTGGLSRSCFLSMQTDGNLVVYNPSNKPIWASNTGGQNGNYVCILQKDRNVVIYGTDRWATG

SEQ ID NO: 10 - protein, 170 aa, synthetic construct
TRADLQGGEAAEKVFRRSPTCIPSGQPCPYNENCCSQSCTFKENENGNTVKRCDAAADNILYSGETLSTGEFLNYGSFVFIMQEDCNLVLYDVDKPIWATNTGGLSRSCFLSMQTDGNLVVYNPSNKPIWASNTGGQNGNYVCILQKDRNVVIYGTDRWATGVDHHHHHH

SEQ ID NO: 11 - protein, 170 aa, synthetic construct
TRADLQGGEAAEKVFRRSPTCIPSGQPCPYNENCCSQSCTFKENENGNTVQRCDAAADNILYSGETLSTGEFLNYGSFVFIMQEDCNLVLYDVDKPIWATNTGGLSRSCFLSMQTDGNLVVYNPSNKPIWASNTGGQNGNYVCILQKDRNVVIYGTDRWATGVDHHHHHH

SEQ ID NO: 12 - protein, 153 aa, synthetic construct
DNILYSGETLSTGEFLNYGSFVFIMQEDCNLVLYDVDKPIWATNTGGLSRSCFLSMQTDGNLVVYNPSNKPIWASNTGGQNGNYVCILQKDRNVVIYGTDRWATGAAASPTCIPSGQPCPYNENCCSQSCTFKENENGNTVKRCDVDHHHHHH

SEQ ID NO: 13 - protein, 154 aa, synthetic construct
AAAHHHHHHDNILYSGETLSTGEFLNYGSFVFIMQEDCNLVLYDVDKPIWATNTGGLSRSCFLSMQTDGNLVVYNPSNKPIWASNTGGQNGNYVCILQKDRNVVIYGTDRWATGAAASPTCIPSGQPCPYNENCCSQSCTFKENENGNTVQRCD

SEQ ID NO: 14 - protein, 118 aa, synthetic construct
EAEAAAASCNGVCSPFEMPPCGSSACRCIPVGLLIGYCRNPSGVFLKGNDEHPNLCESDADCKKKGSGNFCGHYPNPDIEYGWCFASKSEAEDVFSKITPKDLLKSVSTAVDHHHHHH

SEQ ID NO: 15 - protein, 226 aa, synthetic construct
EAEAAAASCNGVCSPFEMPPCGSSACRCIPVGLLIGYCRNPSGVFLKGNDEHPNLCESDADCKKKGSGNFCGHYPNPDIEYGWCFASKSEAEDVFSKITPKDLLKSVSTAAAADNILYSGETLSTGEFLNYGSFVFIMQEDCNLVLYDVDKPIWATNTGGLSRSCFLSMQTDGNLVVYNPSNKPIWASNTGGQNGNYVCILQKDRNVVIYGTDRWATGVDHHHHHH

SEQ ID NO: 16 - protein, 6 aa, synthetic construct
GGGGGG

SEQ ID NO: 17 - protein, 8 aa, synthetic construct
GGGGSAAA

SEQ ID NO: 18 - protein, 15 aa, synthetic construct
GGGGGGGGSAAAAAA

SEQ ID NO: 19 - protein, 12 aa, synthetic construct
GSSGSSAAAAAA

(19) United States
(12) Patent Application Publication
(10) Pub. No.: US 2025/0255310 A1
(43) Pub. Date: Aug. 14, 2025

(54) ENHANCING PESTICIDAL ACTIVITY

(71) Applicant: University of Durham, Durham (GB)

(72) Inventor: Elaine Charlotte Fitches, Middlesbrough (GB)

(21) Appl. No.: 18/850,004

(22) PCT Filed: Mar. 23, 2023
(86) PCT No.: PCT/GB2023/050737

§ 371 Date: Sep. 23, 2024

(30) Foreign Application Priority Data
Mar. 24, 2022 (GB) 2204157.8
Jun. 14, 2022 (GB) 2208684.7

(51) Int. Cl. A01N 63/50; A01N 25/24; A01N 63/16; A01P 7/02; A01P 7/04

(52) U.S. Cl. CPC A01N 63/50; A01N 25/24; A01N 63/16; A01P 7/02; A01P 7/04

(57) ABSTRACT

The present disclosure relates to the development of contact pesticide compositions and uses thereof and provides a method of controlling an insect pest, the method comprising administering by contact/topical administration to the pest, a pesticide formulation, which comprises at least one pesticidal recombinant toxin fusion protein, or fragment, or variant thereof.

### FIELD

The present disclosure relates to the development of contact pesticide compositions and uses thereof.

### BACKGROUND

Spider venoms are increasingly recognized as a rich and valuable source of neurotoxins providing a growing pool of candidates with potential for development as novel biopesticides. The majority of spider venom peptides are short (2.5-5 kDa) and disulphide rich and the most characterised are those containing an evolutionary conserved inhibitor cystine knot (ICK) motif (Pineda et al. 2020). The ICK motif, defined as an antiparallel β-sheet stabilised by a cystine knot (Pallagh et al. 1994), provides high levels of chemical and thermal stability as well as resistance to proteolytic degradation in the insect gut and haemolymph (Craik et al. 2001; Herzig et al. 2018). Such properties are of significant importance for commercial production and viability as biopesticides. Indeed the registration of Spear™T by Vestaron in 2014, which contains the spider venom neurotoxic peptide GS-ω/κ-hexatoxin (HxTx)-Hv1h (named as GS-ω/κ-HxTx-Hv1a by Vestaron) as the active ingredient, provides evidence of the potential for the commercialisation of venom peptide based biopesticides.

GS-ω/κ-HxTx-Hv1h is a member of the ω-HxTx-1 family which were among the first peptides isolated from the venom of Australian funnel-web spider, Hadronyche versuta (Atkinson et al. 1996; Fletcher et al. 1997). Well studied members of sub-groups of the hexatoxin superfamily, thought to have evolved from a common ancestral gene, also include ω-hexatoxin-Hv1a and hexatoxin-Hv1c. All three toxins have been shown to be potent by injection into a range of insects, but harmless to mammals, and surprisingly non-toxic to honeybees (King & Hardy, 2013). ω-hexatoxin-Hv1a was initially shown to target insect voltage gated calcium channels (Caᵥ) whereas κ-hexatoxin-Hv1c targets calcium activated potassium channels (K_{Ca}) (Tedford et al. 2004; Chong et al. 2007). Whilst structurally similar, the mature amino acid sequences of the three toxins are diverse. GS-ω/κ-HxTx-Hv1h has been designated as a hybrid toxin as it contains critical amino acid residues that are present in either ω-hexatoxin-Hv1a or κ-hexatoxin-Hv1c (Chambers et al., 2019). More recently all three toxins have been shown to act as positive allosteric modulators of insect nicotinic acetylcholine receptors (nAChR) which mediate the actions of acetylcholine, the primary excitatory neurotransmitter in the insect central nervous system (CNS) (Chambers et al. 2019).

Many venom ICK peptides are highly potent by injection but typically much less effective when ingested (Saez & Herzig, 2019). Clearly neurotoxic peptides must access the CNS or peripheral nervous system (PNS) to reach their target site(s) of action and failure of ingested peptides to cross the gut epithelium is thought to be the major barrier to achieving oral efficacy. Thus, there is a need to develop novel pesticides with enhanced activity, such as through enhancing delivery of oral pesticides to the CNS and/or PNS of the pest or developing improved methods of administration. The inventors have previously demonstrated that fusion of a number of different venom neurotoxins, including ω-hexatoxin-Hv1a, to the snowdrop lectin Galanthus nivalis agglutinin (GNA) carrier protein dramatically enhances oral insecticidal activity (Fitches et al., 2004, 2010, 2012). GNA is able to transport attached peptides across the insect gut allowing delivery to the circulatory system. A potential mechanism by which GNA enhances pesticidal activity of the fusion toxin protein (GNA/Hv1a) is likely by reducing susceptibility of the fusion toxin to gut serine proteases (Powell et al., 2019). Similarly, Hv1a when fused to a luteovirus coat protein, which crosses from the aphid gut lumen to the haemocoel has been shown to significantly enhance the oral efficacy of Hv1a towards aphids (Bonning et al., 2014). Furthermore, GNA has been shown to bind to the central nerve chord of lepidopteran larvae and may therefore also mediate delivery of attached toxins to sites of action within the CNS (Fitches et al., 2012).

It is amongst the objects of the present disclosure to obviate and/or mitigate one or more of the aforementioned disadvantages.

### SUMMARY

The present disclosure is based in part on studies of recombinant GS-ω/κ-HxTx-Hv1h and a ω/κ-HxTx-Hv1h/GNA fusion protein for contact activity against pea aphids as exemplars. The results further demonstrate that fusion of recombinant toxins, such as GS-ω/κ-HxTx-Hv1h to GNA enhances, not only oral toxicity, but importantly contact efficacy towards aphids, that is when the toxin is contacted with the exterior surface of the aphid and is not ingested. The GNA fusion toxin proteins of the present disclosure, when delivered through the exterior surface of a pest by contact administration as described herein, results in an unexpected enhanced pesticidal activity over the use of a toxin protein alone. The enhanced pesticidal performance of the fusion protein is surprising, as the role of the carrier protein GNA to reduce susceptibility to gut serine proteinases and facilitate transport across the gut epithelium following ingestion (Powell et al., 2019), and would not be expected to have an effect when not administered via the gut. Similarly, the inventors have surprisingly identified that a structurally similar ICK motif containing peptide derived from a sulphur-rich pea albumin protein PA1 fused to GNA demonstrates enhanced contact pesticidal activity.

In a first aspect, the present disclosure provides a method of controlling an insect pest, the method comprising administering by contact/topical administration to the pest, a pesticide formulation which comprises at least one pesticidal recombinant toxin fusion protein.

Often, according to particular embodiments of the first aspect the insect pest is a plant pest or a pest of bees, for example honeybees.

The term ‘pest’ used throughout this disclosure includes insects (e.g., ants, cockroaches, mosquitos), mites, pest of bees (e.g. small hive beetle, parasitic mites (Varroa destructor)), molluscs (e.g. slugs and snails) and nematodes (e.g. roundworms) that eat plants (especially crop plants) and/or trees, or parts thereof such as leaves, sap, flowers, seeds, and/or fruit. The method of controlling a pest (also referred to as pest management) through contact/topical administration involves inducing negative effects on an adult and/or larval form of the pest by inhibiting growth, impairing movement, impairing reproduction, impairing its metabolic activity and/or killing. The term “pesticide” or “pesticidal” is not therefore intended to refer only to the ability to kill pests, but also includes the ability to interfere with a pest's life cycle in any way that results in an overall reduction in the pest population.

Through contact administration, the pesticidal recombinant toxin fusion protein is capable of destroying, or at least debilitating plant pests and pests of honeybees. Examples of plant and honeybee pests include, but are not limited to, thrips (Thysanoptera), whiteflies (Aleyrodidae), aphids (Aphidoidea), plant lice (Psyllidae), beetles (Coleoptera), spider mites (Tetranychidae), broad mites (Tarsonemidae), planthopper (Delphacidae), flies (Diptera), moths (Lepidoptera) or their larva, cockroaches (Blattodea), or ants (Formicidae). In one embodiment, the pesticidal recombinant toxin fusion protein as described herein is for use in controlling aphids, psyllids, thrips, whiteflies, mites and/or their larva delivered through contact administration.

The pesticide formulation delivered through contact administration as described herein comprises one or more recombinant toxin fusion proteins. In one embodiment, the pesticidal recombinant toxin fusion protein comprises a neurotoxin, which may be selected from arachnid-derived toxins or insect-derived toxins. In one embodiment, arachnid-derived toxin may be a spider toxin, which typically function as neurotoxins. Examples of such neurotoxins include, but are not limited to, hexatoxins (κ-, δ- or ω-hexatoxin (HxTx)), omega-atracotoxin (ω-atracotoxin), delta-atracotoxin (also known as δ-ACTX-Ar1, robustoxin or robustotoxins), Cupiennius salei toxin and spider potassium channel inhibitory toxin (e.g., hanatoxin, heteropodatoxin). Other examples of peptide venom toxins may include those derived from Hymenoptera (e.g., poneratoxin from Paraponera clavate), Threonine(6)-Bradykinin from venom of social wasps such as Polybia accidentalis).

In one embodiment, the toxin of the pesticidal recombinant fusion protein(s) of the disclosure are selected from hexatoxins. For example, Hadroncyhe versuta produces the toxins ω-hexatoxin-Hv1e, ω-hexatoxin-Hv1c, ω-hexatoxin-Hv1d, ω-hexatoxin-Hv1g, and ω-hexatoxin-Hv1b, which each have a very high level of sequence identity (only a few amino acid substitutions or deletions between each toxin). The Sydney funnel-web spider (Atrax robustus) produces the toxin protein ω-hexatoxin-Ar1d, which has an identical amino acid sequence to ω-atracotoxin-Hv1a, and ω-hexatoxin-Hv1h and ω-hexatoxin-Ar1f, which have a very high level of sequence identity. Further, toxins are produced by the oblong running spider, Tibellus oblongus (Omega-Tbo-IT1 toxin) Toowoomba funnel-web spider, Hadronyche infensa (e.g., ω-hexatoxin-Hi1b, ω-hexatoxin-Hi1d, ω-hexatoxin-Hi1e, ω-hexatoxin-Hi1f) and the Tasmanian funnel-web spider, Hadronyche venenata (e.g., hexatoxin-Hvn1b, hexatoxin-Hvn1b) and the Northern tree-dwelling funnel-web spider Hadronyche formidabilis (hexatoxin-Hf1a). Further toxins are produced by Arachnids such as AaHIT from the scorpion Androctonus australis and OdTx12 from the scorpion Odontobuthus doniae.

Exemplary hexatoxins used herein may be selected from the sequences identified below:

ω-hexatoxin-Hv1a
(SEQ ID NO: 1)
SPTCIPSGQPCPYNENCCSQSCTFKENENGNTVKRCD
GS-ω/κ-HxTx-Hv1h
(SEQ ID NO: 2)
GSQYCVPVDQPCSLNTQPCCDDATCTQERNENGHTVYYCRA
ω-hexatoxin-Hv1g
(SEQ ID NO: 3)
QYCVPVDQPCSLNTQPCCDDATCTQELNENDNTVYYCRA

Peptides comprising ICK motifs (referred to as ICK peptides herein) are evolutionarily conserved across phyla. ICK peptides are particularly abundant in cone snail and spider venoms and are known to inhibit voltage gated ion channels (Fletcher et al., 1997). An ICK peptide or ICK protein comprises a structural motif containing three disulphide bridges, wherein the ICK motif is defined as an antiparallel β-sheet stabilised by a cystine knot. ICK peptide or ICK protein or ICK toxin as used herein refers to a peptide, protein or toxin that comprises one or more ICK motifs. It is envisaged that toxins that comprise one or more ICK motifs, which are not necessarily derived from insects or arachnids, may also be effective as a pesticidal recombinant toxin fusion protein for contact/topical administration as disclosed herein. For example, a sulphur-rich pea albumin protein in Pisum sativum seeds called PA1 is expressed in seeds as a preproprotein, which is cleaved into its mature proteins PA1a and PA1b. PA1b is a 37 amino acid peptide containing 6 cysteine residues that form 3 intramolecular di-sulfide bridges and is ICK peptide. PA1b is structurally similar to an ICK atracotoxin present in the venom of the Australian funnel web spider Hadronyche infensa, which may be used as a pesticidal toxin. Thus, a recombinant fusion protein comprising a peptide derived from pea albumin was utilised as an exemplary non-arachnid derived toxin herein.

Exemplary pea albumin used herein comprise the sequence below:

Pea albumin (PAF)
(SEQ ID NO: 14)
EAEAAAASCNGVCSPFEMPPCGSSACRCIPVGLLIGYCRNPSGVFLKGN
DEHPNLCESDADCKKKGSGNFCGHYPNPDIEYGWCFASKSEAEDVFSKI
TPKDLLKSVSTAVDHHHHHH

In one embodiment, the pesticidal recombinant toxin fusion protein for contact administration as described herein comprises an ICK motif containing protein or peptide, wherein the ICK motif containing protein or peptide comprises one or more ICK motifs. In one embodiment, the pesticidal recombinant toxin fusion protein for contact administration as described herein comprises an ICK motif containing protein or peptide, or fragment, or variant thereof.

In one embodiment, the pesticidal recombinant toxin fusion protein for contact administration as described herein comprises a pea albumin protein derived from Pisum sativum seeds. In a preferred embodiment, the pesticidal recombinant toxin fusion protein for contact administration comprises PA1a or PA1b, or fragment, or variant thereof.

The recombinant toxin proteins (as well as variants or fragments thereof) as disclosed herein are fused to another peptide or protein to form a pesticidal fusion protein. Typically, the fusion protein may be generated, by expression of translationally coupled sequences encoding the recombinant toxin protein (as well as variants or fragments thereof) as disclosed herein, together with another protein or peptide. The other protein or peptide may be directly linked in frame with nucleic acid encoding the recombinant protein, such that the other protein/peptide is directly fused to the N-, or C-terminus of the recombinant toxin, for example. Alternatively, a linker sequence may be provided, in order that there is a gap between the recombinant toxin and the other protein/peptide. Use of such a linker may facilitate with the folding of the fusion protein, for example. Exemplary linker sequences include (G)nS(A)n (SEQ ID NO: 4), (G)n (SEQ ID NO: 16), (GGGGS)n (SEQ ID NO: 5), where n is 2-6, GGGGSAAA (SEQ ID NO: 17), GGGGGGGGSAAAAAA (SEQ ID NO: 18) and GSSGSSAAAAAA (SEQ ID NO: 19).

The toxin portion of the pesticidal recombinant fusion protein may be full-length wild type toxin protein, or may comprise a variant or fragment thereof. A “variant” or “fragment” of the recombinant toxin protein of the disclosure can comprise an amino acid sequence of the toxin protein that varies from a wild-type sequence, with the proviso that the variant or fragment substantially retains at least 50%, 60%, 70%, 80%, 90%, or 95% of the biological activity of the wild-type sequence. In particular, single like for like changes with respect to the physio-chemical properties of the respective wild-type amino acid may not disturb the functionality, and moreover small deletions or additions within non-functional regions of the protein toxin can also be tolerated and hence are considered “variants” for the purpose of the present invention. The experimental procedures described herein can be readily adopted by the skilled person to determine whether a “variant” or “fragment” still possesses sufficient biological activity. A “variant” may also include recombinant toxin proteins or fragments with appended affinity tags for purification, such as a His-tag, FLAG-tag, HA-tag or Myc-tag and/or facilitate expression, such as the dipeptide, GS appended to the N-terminus of the toxin. A “fragment” refers to when a portion of the N- and/or C-terminus has been deleted. For example, in one embodiment, a fragment of the toxin protein is a peptide that comprises at least 80%, 90% or 95% of the full-length wild-type toxin.

The toxin fusion proteins as described herein are typically less than 300, 200, or 150 amino acids in length. A variant or fragment of the toxin protein may differ in length and/or differ in sequence from the naturally occurring protein by up to, for example, 1, 2, 3, 4, 5, 6, 7, 8, 9, 10, 15 or 20 amino acid residues.

In one embodiment, the pesticidal toxin protein (as well as variants or fragments thereof) may be fused to a carbohydrate binding module (CBM). It is known in the art that CBMs are protein modules found in glycoside hydrolases that bind polysaccharides. A CBM is defined as contiguous amino acid sequence within a carbohydrate-active enzyme with a discreet fold having carbohydrate-binding activity. CBM protein modules can range in length from 40 to 150 amino acids. There over 85 different families of CBMs recognized in the CAZy (Carbohydrate-Active enZYmes) database. Carbohydrate binding modules may be derived from various organisms, such as plants and microoganisms (e.g., bacteria, fungi). In one embodiment, the toxin protein may be fused to either the N-terminus or the C-terminus of the CBM. In one embodiment, the toxin protein is bound to the N-terminus of the CBM.

In one embodiment, the toxin protein may be fused to a lectin. The term lectin as used herein refers to any molecules including proteins, natural or genetically modified, that interact specifically with saccharides (e.g., carbohydrates). The term lectin as used herein can also refer to lectins derived from any species, including, but not limited to, plants, animals, insects and microorganisms, having a desired carbohydrate binding specificity. Examples of plant lectins include, but are not limited to, the Leguminosae lectin family, such as Concanavalin A, soybean agglutinin, peanut lectin, lentil lectin and Galanthus nivalis agglutinin (GNA) from the Galanthus (snowdrop) plant (GNA is also known as snowdrop lectin). Other examples of plant lectins are the Gramineae and Solanaceae families of lectins. Examples of animal lectins include, but are not limited to, any known lectin of the major groups S-type lectins, P-type lectins, I-type lectins, C-type lectins and mannose-binding lectins.

Other exemplary lectins that may be fused to the pesticidal recombinant toxin proteins are collectins. Collectins are soluble pattern recognition receptors belonging to the superfamily of collagen containing C-type lectins. Further exemplary lectins include, without limitations, mannose-binding lectin (also known as mannan-binding lectin, mannan-binding protein, or mannose-binding protein), surfactant protein D, collectin liver 1, collectin placenta 1, conglutinin, collectin of 43 kDa, collectin of 46 kDa or a variant thereof. In one embodiment, the CBM of the recombinant toxin fusion protein may be a mannose-binding lectin. Exemplary mannose-binding lectins include mannose-binding ginger (Zingiber officinale) lectin and mannose-binding garlic (Allium sativum) lectin. In a certain embodiment, the lectin comprises a GNA or a variant thereof.

In one embodiment, the fusion protein may comprise or consist of a toxin, such as an ICK toxin or ICK motif containing peptide (as well as variants or fragments thereof), fused to GNA.

In some embodiments, the fusion protein may comprise or consist of a toxin derived from pea albumin (as well as variants or fragments thereof), fused to GNA. In some embodiments, the fusion protein may comprise or consist of PAF fused to GNA.

In one embodiment, the fusion protein may comprise or consist of a toxin, such as a spider toxin (as well as variants or fragments thereof), fused to GNA.

In a certain embodiment, the fusion protein may comprise or consist of a hexatoxin (as well as variants or fragments thereof), fused to GNA.

In an alternative embodiment, the fusion protein may comprise or consist of HxTx-Hv1h fused to GNA.

In one embodiment, the fusion protein may comprise or consist of GS-ω/κ-HxTx-Hv1h fused to GNA.

### Exemplary Toxin-GNA Fusion Sequences are Provided Below

1. GS-ω/κ-HxTx-Hv1h/GNA
(SEQ ID NO: 6)
GSQYCVPVDQPCSLNTQPCCDDATCTQERNENGHTVYYCRAGGGGSAAA
DNILYSGETLSTGEFLNYGSFVFIMQEDCNLVLYDVDKPIWATNTGGLS
RSCFLSMQTDGNLVVYNPSNKPIWASNTGGQNGNYVCILQKDRNVVIYG
TDRWATGVDHHHHHH
2.GNA/GS-ω/κ-HxTx-Hv1h
(SEQ ID NO: 7)
HHHHHHDNILYSGETLSTGEFLNYGSFVFIMQEDCNLVLYDVDKPIWAT
NTGGLSRSCELSMQTDGNLVVYNPSNKPIWASNTGGQNGNYVCILQKDR
NVVIYGTDRWATGGGGSAAAGSQYCVPVDQPCSLNTQPCCDDATCTQER
NENGHTVYYCRA
3. ω-hexatoxin-Hv1a/GNA
(SEQ ID NO: 8)
SPTCIPSGQPCPYNENCCSQSCTFKENENGNTVKRCDAAADNILYSGET
LSTGEFLNYGSFVFIMQEDCNLVLYDVDKPIWATNTGGLSRSCFLSMQT
DGNLVVYNPSNKPIWASNTGGQNGNYVCILQKDRNVVIYGTDRWATGVD
HHHHHH
4. ω-hexatoxin-Hv1a (K-Q mutation)/GNA
(SEQ ID NO: 9)
ASPTCIPSGQPCPYNENCCSQSCTFKENENGNTVQRCDAAADNILYSGE
TLSTGEFLNYGSFVFIMQEDCNLVLYDVDKPIWATNTGGLSRSCFLSMQ
TDGNLVVYNPSNKPIWASNTGGQNGNYVCILQKDRNVVIYGTDRWATG
5. Pro-ω-hexatoxin-Hv1a/GNA
(SEQ ID NO: 10)
TRADLQGGEAAEKVFRRSPTCIPSGQPCPYNENCCSQSCTFKENENGNT
VKRCDAAADNILYSGETLSTGEFLNYGSFVFIMQEDCNLVLYDVDKPIW
ATNTGGLSRSCFLSMQTDGNLVVYNPSNKPIWASNTGGQNGNYVCILQK
DRNVVIYGTDRWATGVDHHHHHH
6. Pro-ω-hexatoxin-Hv1a (K-Q mutation)/GNA
(SEQ ID NO: 11)
TRADLQGGEAAEKVERRSPTCIPSGQPCPYNENCCSQSCFKENENGNTV
QRCDAAADNILYSGETLSTGEFLNYGSFVFIMQEDCNLVLYDVDKPIWA
TNTGGLSRSCFLSMQTDGNLVVYNPSNKPIWASNTGGQNGNYVCILQKD
RNVVIYGTDRWATGVDHHHHHH
7. GNA/ω-hexatoxin-Hv1a/His
(SEQ ID NO: 12)
DNILYSGETLSTGEFLNYGSFVFIMQEDCNLVLYDVDKPIWATNTGGLS
RSCFLSMQTDGNLVVYNPSNKPIWASNTGGQNGNYVCILQKDRNVVIYG
TDRWATGAAASPTCIPSGQPCPYNENCCSQSCTFKENENGNTVKRCDVD
HHHHHH
8. His/GNA/ω-hexatoxin-Hv1a (k-Q mutation)
(SEQ ID NO: 13)
AAAHHHHHHDNILYSGETLSTGEFLNYGSFVFIMQEDCNLVLYDVDKPI
WATNTGGLSRSCFLSMQTDGNLVVYNPSNKPIWASNTGGQNGNYVCILQ
KDRNVVIYGTDRWATGAAASPTCIPSGQPCPYNENCCSQSCTFKENENG
NTVQRCD
9. PAF/GNA/His fusion protein sequence
(SEQ ID NO: 15)
EAEAAAASCNGVCSPFEMPPCGSSACRCIPVGLLIGYCRNPSGVELKGN
DEHPNLCESDADCKKKGSGNFCGHYPNPDIEYGWCFASKSEAEDVFSKI
TPKDLLKSVSTAAAADNILYSGETLSTGEFLNYGSFVFIMQEDCNLVLY
DVDKPIWATNTGGLSRSCFLSMQTDGNLVVYNPSNKPIWASNTGGQNGN
YVCILQKDRNVVIYGTDRWATGVDHHHHHH

The present disclosure is based upon contact administration to a pest. In accordance with the disclosure, but without wishing to be bound by theory, it is thought that the pesticidal recombinant toxin fusion protein may be absorbed through an outer surface area (exoskeleton or integument) of the pest and/or be translocated via respiratory openings known as spiracles. Thus, the recombinant toxin fusion protein as described herein is delivered through contact administration to the pest.

Contact administration (or also referred to as topical administration) comprises applying the pesticidal recombinant toxin fusion protein such that the recombinant toxin fusion protein comes into contact with at least a portion of the exoskeleton/integument of a pest. Contact administration may mean direct application of the pesticide composition to the pest. In another instance, contact administration may refer to indirect or secondary application whereby the pesticide is topically transferred to the pest or larva through contact with a pesticide-treated surface. For the avoidance of doubt, although the pesticide could be ingested by the pest during topical administration, the present disclosure is based on the surprising discovery that recombinant toxins can induce an enhanced toxic effect as compared to toxin alone through contact with the exoskeleton/integument of the pest.

The method of contact administration may involve applying the pesticidal recombinant toxin fusion protein to the environment of the pest, such as through spraying, application as fogs or mists, painting or brushing onto surfaces, or through other similar methods likely to expose the pest to the pesticidal toxin fusion protein. Other exemplary methods include applying droplets of the pesticidal recombinant protein in solution or using an atomizer to disperse the pesticide toxin to contact the pest.

The pesticidal recombinant fusion protein is administered in the form of a pesticide formulation. A pesticide formulation comprises the pesticidal recombinant toxin protein formulated together with one or more acceptable excipients, carriers and/or adjuvants. In one embodiment, the adjuvant may be an oil and/or emulsifying surfactant formulated for agricultural application of pesticides. In a certain embodiment, the pesticidal formulation comprises non-ionic spreading and penetration surfactant (e.g., Polysorbate 20, Break-Thru®). Commercial formulations typically have oils and/or emulsifying surfactants to facilitate the dispersion of the active ingredients, such as methylated or ethylated vegetable oil. In some examples, the pesticidal recombinant fusion protein formulation may be an aqueous solution, comprising one or more non-ionic organosilicone surfactants with enhanced wetting and spreading characteristics (e.g. Silwet, CapSil).

The pesticidal formulation may be applied singly or in combination with other compounds/formulations, including but not limited to other pesticides. They may be used in conjunction with other excipients such as surfactants, detergents, polymers. The pesticidal formulation may also be in the form of a time-release formulation, in which the pesticidal toxin fusion protein is released over a period of time, such as over a period of hours, for example 2-12 hours. The pesticidal formulations may also comprise one or more pest attractants, such as pheromones, plant volatiles, flower oils, sugars, proteins and/or other molecules known in the art to function as pest attractants.

In one embodiment, the pesticide recombinant toxin fusion protein may be formulated in combination with an excipient designed to facilitate adherence to the outer surface of the pest. For instance, the excipient may comprise a sticky solution comprised of sugar solution or any other substance that enhances binding of the pesticide recombinant protein to the outer surface or integument (epicuticle, exocuticle, endocuticle and/or epidermis) of the pest.

In one embodiment, there is provided a pesticide formulation as described herein formulated as a sticky solution for promoting attachment to the outer surface or integument (epicuticle, exocuticle, endocuticle and/or epidermis) of the pest and subsequent absorption through the outer surface or integument.

In one embodiment, there is a provided a use of a pesticide formulation as described herein in a method of controlling pests wherein the pesticide formulation is to be administered by way of contacting the pest.

The recombinant toxin fusion proteins as described herein may be provided by methods of preparing nucleic acid molecules encoding recombinant toxin/fusion proteins (as well as variants or fragments thereof) through routine molecular biology techniques known in the art. The term recombinant fusion protein as used herein also includes the possibility that the fusion protein may be made by de novo chemical synthesis techniques known in the art. A variety of methods have been developed to link polynucleotides to form continuous single or double strands, especially double-stranded DNA, for example via complementary cohesive termini produced by digestion with restriction enzymes. Suitable methods are described in Sambrook et al. (2000) Molecular Cloning, A Laboratory Manual, Cold Spring Harbor Laboratory, Cold Spring Harbor, NY. Such methods can be readily used by the skilled person to prepare a nucleic acid molecule in accordance with the disclosure.

In one embodiment, nucleic acid encoding the recombinant toxin fusion protein is provided within an expression construct. An “expression construct” is a term well known in the art. Expression constructs are basic tools for the production of recombinant proteins in biotechnology. The term “construct” refers to non-naturally occurring nucleic acid molecule. A construct may refer to a polynucleotide that encodes a fusion polypeptide. A construct can further comprise a circular or linear vector and can be combined with other polynucleotides, for example by homologous recombination. The term “vector” refers to a nucleic acid molecule capable of transporting another nucleic acid to which it has been linked. One type of vector is a “plasmid’, which refers to a circular double stranded DNA loop into which additional DNA segments can be ligated. Another type of vector is a viral vector wherein additional DNA segments can be ligated into the viral genome. Certain vectors are capable of autonomous replication in a host cell into which they are introduced (e.g., bacterial vectors having a bacterial origin of replication and episomal mammalian vectors). Other vectors (e.g., non-episomal mammalian vectors) are integrated into the genome of a host cell upon introduction into the host cell, and thereby are replicated along with the host genome. The vectors of the present invention are capable of directing the expression of genes encoding target polypeptides to which they are operatively linked. Such vectors are referred to herein as “expression vectors”. In general, expression vectors of utility in recombinant DNA techniques are often in the form of plasmids. In the present specification, “plasmid” and “vector” can be used interchangeably as the plasmid is the most commonly used form of vector.

The expression construct generally includes a plasmid that is used to introduce a desired coding sequence and appropriate nucleic acid sequences necessary for the expression of the operably linked coding sequence in a particular host cell. Nucleic acid sequences necessary for expression in prokaryotes include a promoter, optionally an operator sequence, a ribosome binding site and possibly other sequences. Eukaryotic cells are known to utilize promoters, enhancers, and termination and polyadenylation signals. A secretory signal peptide sequence can also, optionally, be encoded by the recombinant expression vector, operably linked to the coding sequence for the recombinant protein, such as a recombinant fusion protein, so that the expressed fusion protein can be secreted by the recombinant host cell, for easier isolation of the fusion protein from the cell, if desired. The term includes the vector as a self-replicating nucleic acid structure as well as the vector incorporated into the genome of a host cell into which it has been introduced.

Suitable expression constructs comprising nucleic acid for introduction into microorganisms and higher organisms can be chosen or constructed, containing appropriate regulatory sequences, including promoter sequences, terminator fragments, enhancer sequences, marker genes and other sequences as appropriate. For further details, see, for example, Molecular Cloning: a Laboratory Manual: 2nd edition, Sambrook et al. supra. The nucleic acid for expression in a suitable host organism, can also be codon optimised for expression in the chosen host, which is well-known to the skilled addressee.

Once the expression construct is inside the cell, protein that is encoded by that gene is produced by the cellular transcription and translation machinery ribosomal complexes. The plasmid also includes nucleic acid sequences required for maintenance and propagation of the vector, in some cases through integration into the host genome. The goal of an expression vector is the production of large amounts of stable messenger RNA, and therefore proteins.

A variety of recombinant expression systems are known in the art, including bacterial, yeast, and mammalian host cell systems, and many different proteins have been successfully produced in these systems. Vector DNA can be introduced into prokaryotic or eukaryotic cells via conventional transformation or transfection techniques known in the art. As used herein, the terms “transformation” and “transfection” are intended to refer to a variety of art recognized techniques for introducing foreign nucleic acid (e.g., DNA) into a host cell, including calcium phosphate or calcium chloride co-precipitation, DEAE-dextran-mediated transfection, lipofection, or electroporation. Suitable methods for transforming or transfecting host cells can be found in Sambrook, et al. (MOLECULAR CLONING: A LABORATORY MANUAL. 2nd ed., Cold Spring Harbor Laboratory, Cold Spring Harbor Laboratory Press, Cold Spring Harbor, N.Y., 1989), and other laboratory manuals.

### DETAILED DESCRIPTION

The present disclosure will now be further described by way of example and with reference to Figures, which show:

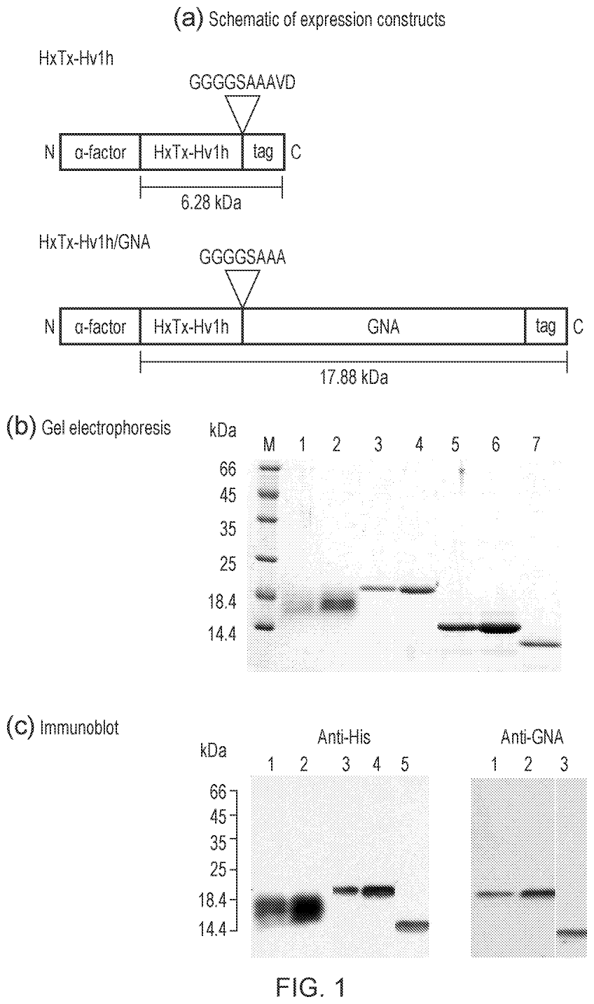

FIG. 1. (a) Schematic of expression constructs: schematic of constructs encoding recombinant HxTx-Hv1h and HxTx-Hv1h/GNA produced in the yeast P. pastoris showing predicted molecular masses. Tag denotes the presence of a six-residue histidine sequence that allows protein purification by nickel affinity chromatography and detection by western blotting. (b) Gel electrophoresis: separation of purified proteins by SDS-PAGE gel stained for total protein: lanes 1 and 2 are HxTx-Hv1h, lanes 3 and 4 are HxTx-Hv1h/GNA, lanes 5 and 6 are recombinant GNA and lane 7 is Sigma GNA standard (2 μg). (c) Immunoblot: western analysis of recombinant proteins using anti-His (lanes 1-5 are as for B) and anti-GNA (lanes 1 and 2 are HxTx-Hv1h/GNA, lane 3 is Sigma GNA standard 50 ng) antibodies. Location of mass markers run on the same gel are depicted.

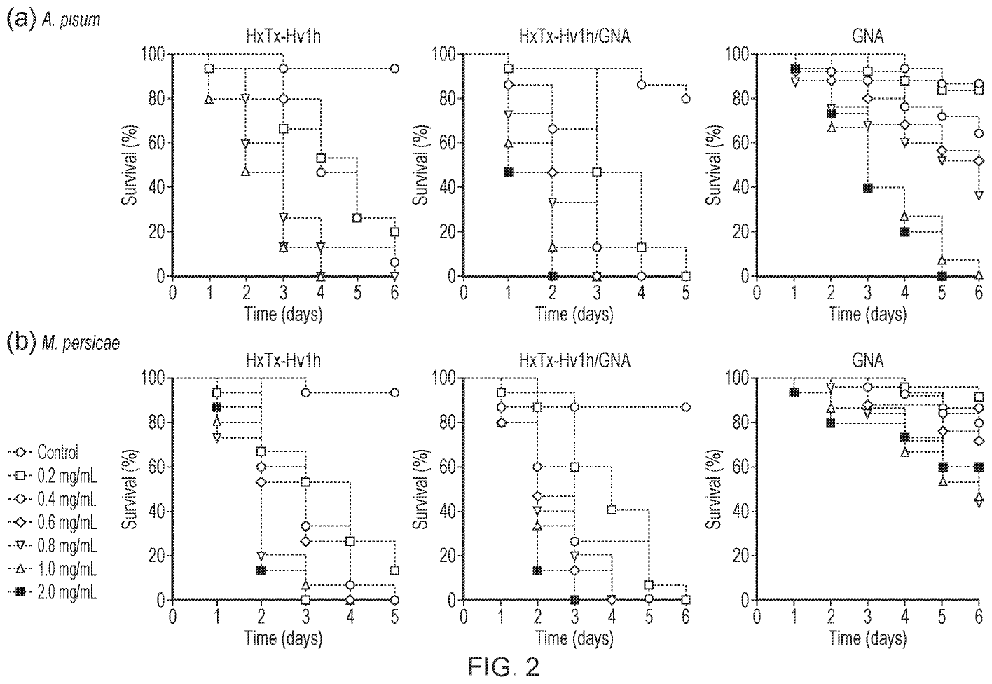

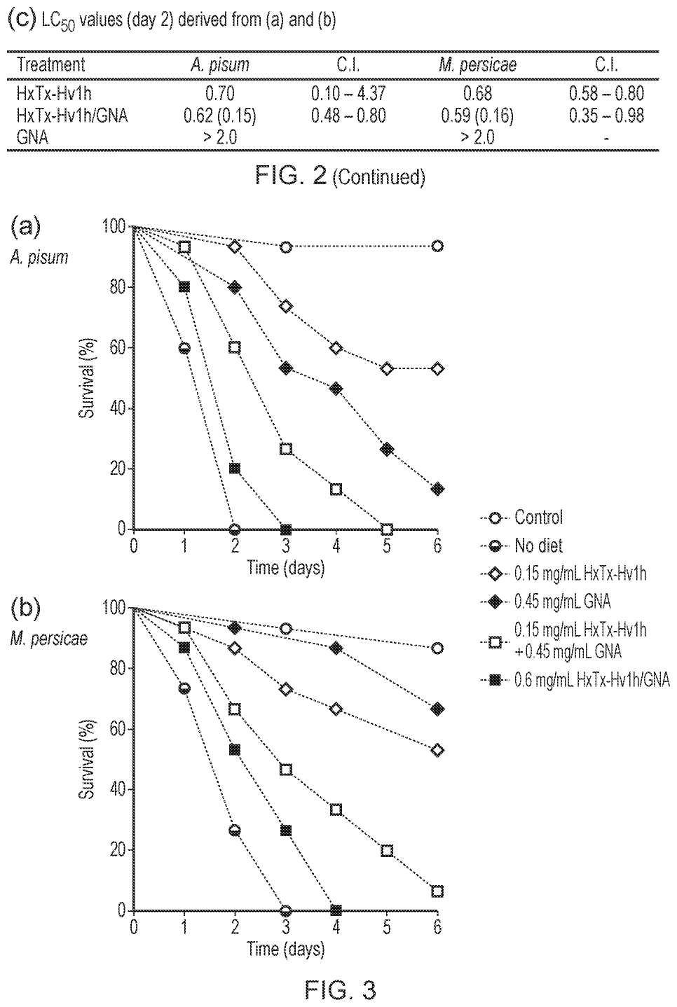

FIG. 2. Survival of (a) A. pisum and (b) M. persicae fed on diets containing different concentrations of HxTx-Hv1h, HxTxHv1h/GNA or GNA. (c) Day 2 LC₅₀ values (mg/mL) derived from bioassay data in (a) and (b). C.I. depicts confidence intervals and numbers in brackets are relative amounts of toxin in the fusion protein treatments.

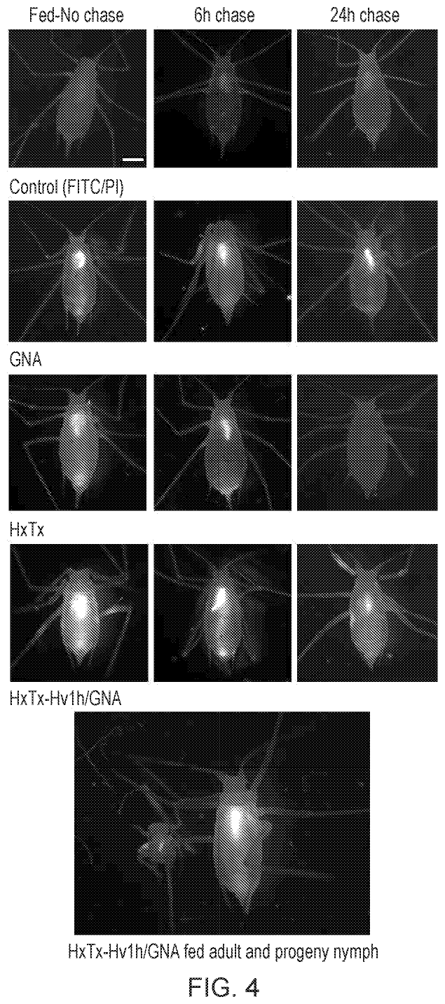

FIG. 3. Survival of (a) A. pisum and (b) M. persicae fed on diets containing HxTx-Hv1h, GNA, HxTx-Hv1h/GNA and an equivalent mixture of HxTx-Hv1h and GNA.

FIG. 4. Composite of whole A. pisum fed on diets containing FITC labelled proteins or control-FITC/PI for 24 h followed by chase feeding on control diets for 6 and 24 h. Images were visualised with a fluorescent microscope under FITC filter and captured in OpenLab Scale bar=0.5 mm. Bottom frame shows an adult (fed on FITC-fusion protein for 24 h, placed in a feeding chamber overnight) and emerged nymph.

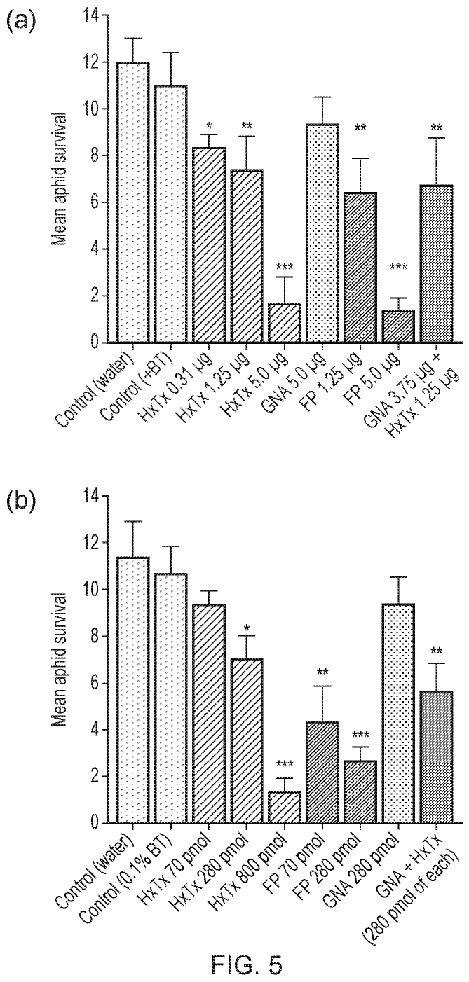

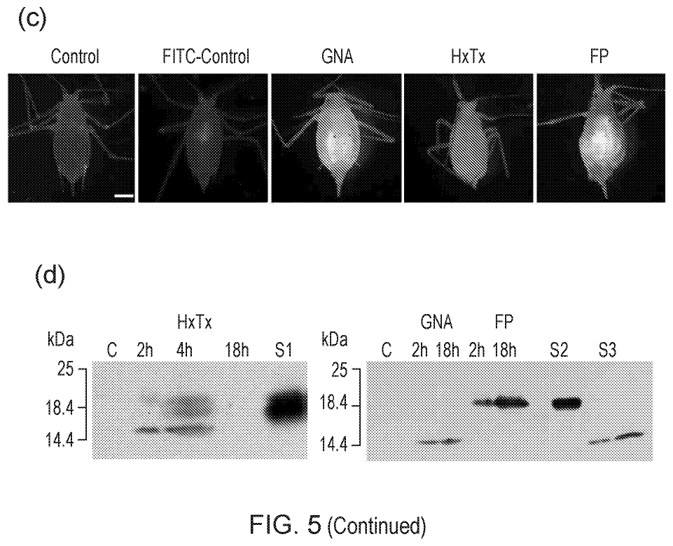

FIG. 5. (a) Pea aphid survival 24 h after contact exposure to water, water+Breakthru (BT), different amounts of HxTx-Hv1h (HxTx), or GNA, or HxTx-Hv1h/GNA (FP) or a mixture of GNA and toxin. All protein treatments contained Breakthru. Bars depict standard error of the mean (3 replicates of n=15 per dose), * denotes a significant difference to control (+BT) at *P<0.05, **P<0.01, and ***P<0.0001 (t-tests). (b) Pea aphid survival as for 5(a) except that aphids were treated with droplets containing comparable molar concentrations of HxTx, or GNA or FP as depicted. As for 5(a) all protein treatments contained Breakthru. Bars depict standard error of the mean (3 replicates of n=15 per dose), * denotes a significant difference to control (+BT) at *P<0.05, **P<0.01, and ***P<0.0001 (t-tests). (c) Representative images of aphids taken 18 h after contact with droplets containing FITC labelled proteins as follows 0.31 μg HxTx-Hv1h (HxTx), 0.93 μg GNA or 1.25 μg HxTx-Hv1h/GNA (FP). Aphids were fed on control diet and washed prior to imaging under FITC filter captured in OpenLab. Scale bar=0.5 mm. (d) Western analysis (anti-His antibodies) of whole aphid protein extracts extracted 2 and 18 h after contact with droplets containing 2.5 μg HxTx-Hv1h, 7.5 μg GNA and 5 μg fusion protein. S1 depicts HxTx-Hv1h standard (250 ng), S2 is recombinant fusion protein (200 ng) and S3 is (100 and 200 ng) recombinant GNA.

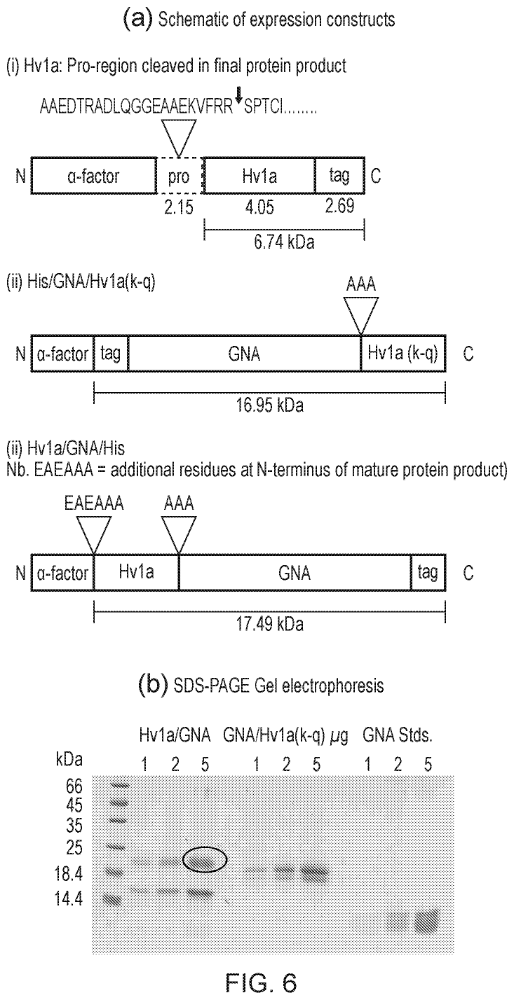

FIG. 6. (a) Schematic of expression constructs: schematic of constructs encoding recombinant Hv1a and His/GNA/Hv1a(k-q) and Hv1a/GNA/His produced in the yeast P. pastoris showing predicted molecular masses. Tag denotes the presence of a six-residue histidine sequence that allows protein purification by nickel affinity chromatography and detection by western blotting. (b) SDS-PAGE Gel electrophoresis: separation of purified Hv1a/GNA/His and His/GNA/Hv1a(k-q) by SDS-PAGE, gel stained with Coomassie Blue for total protein. Circle for Hv1a/GNA/His depicts intact fusion protein, lower mass cleavage product is GNA (as shown by LC-MS analysis of protein digests); both protein bands for GNA/Hv1a(k-q) bands are intact FP (as shown by LC-MS analysis of protein digests).

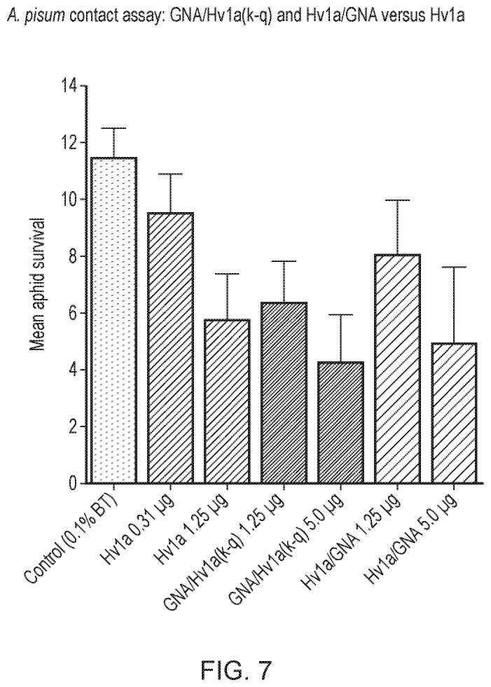

FIG. 7. A. pisum contact assay: pea aphid survival 24 h after contact exposure to control (water+0.01% Breakthru [BT], or Hv1a or GNA/Hv1a(k-q), or Hv1a/GNA. All protein treatments contained Breakthru. Bars depict standard error of the mean (9-12 replicates of n=15 per dose). Nine-twelve biological replicates (15 aphids per replicate) were conducted for each protein treatment and dose; survival was recorded 24 h post treatment.

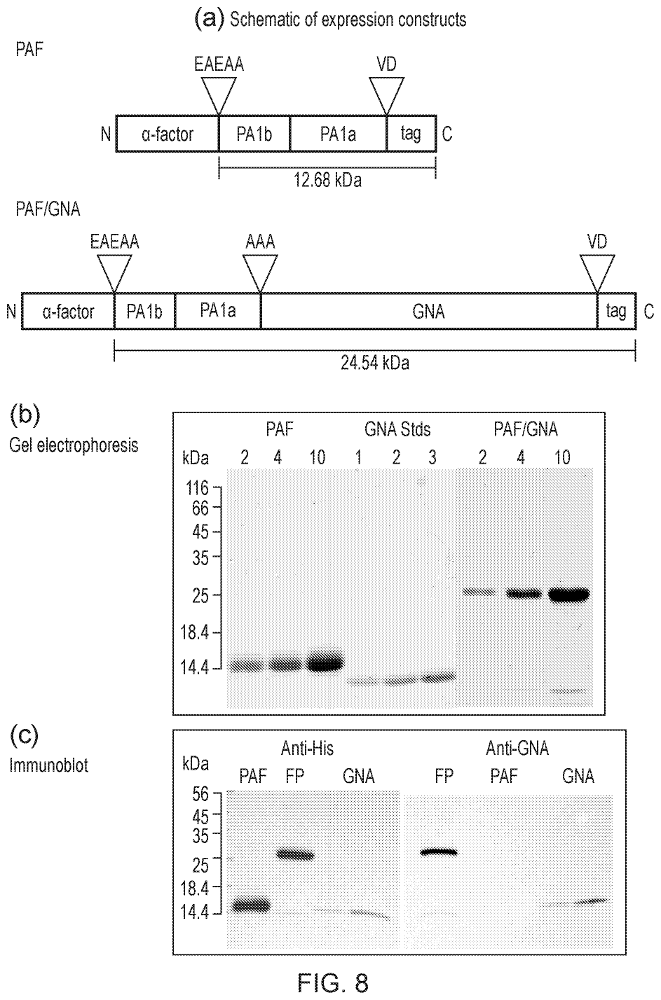

FIG. 8. Schematic of expression constructs: schematic constructs encoding recombinant PAF and PAF/GNA. (a) Schematic of constructs encoding recombinant PAF and PAF/GNA produced in the yeast P. pastoris showing predicted molecular masses; tag denotes the presence of a six-residue histidine sequence enabling protein purification by nickel affinity chromatography and immunoblot detection. (b) Gel electrophoresis: separation of purified proteins by SDS-PAGE gel (17.5% acrylamide) stained for total protein: loading of proteins in μg is depicted. GNA standards are GNA purified from snowdrop bulbs (Sigma-Aldrich, St. Louis, USA). (c) Immunoblot: Western analysis of recombinant proteins using anti-His (400 ng protein loaded) and anti-GNA (200 ng protein loaded) antibodies. Location of mass markers run on the same gel are depicted.

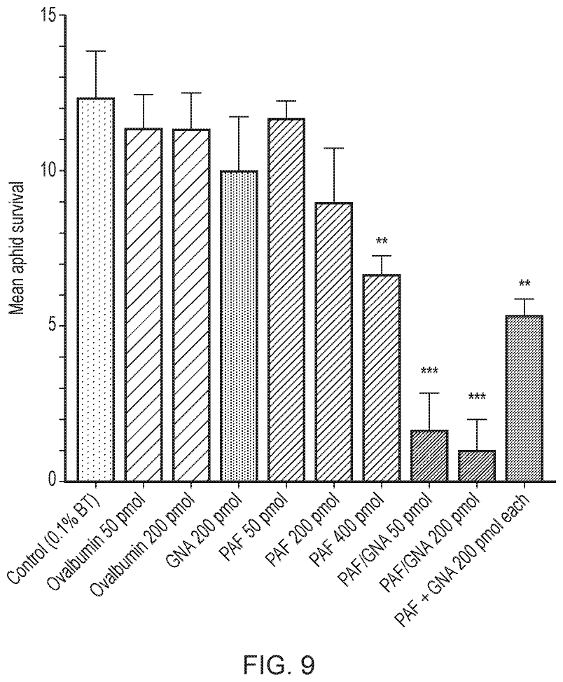

FIG. 9. Pea aphid survival 24 h after contact exposure to water, water+Breakthru (BT), ovalbumin, GNA, PAF, PAF/GNA or a mixture of GNA and PAF. All protein treatments contained BT. Bars depict standard error of the mean (3 replicates of n=15 per dose), * denotes a significant difference to control (+BT) and ovalbumin treatments at **P<0.005, and ***P<0.0005 (t-tests).

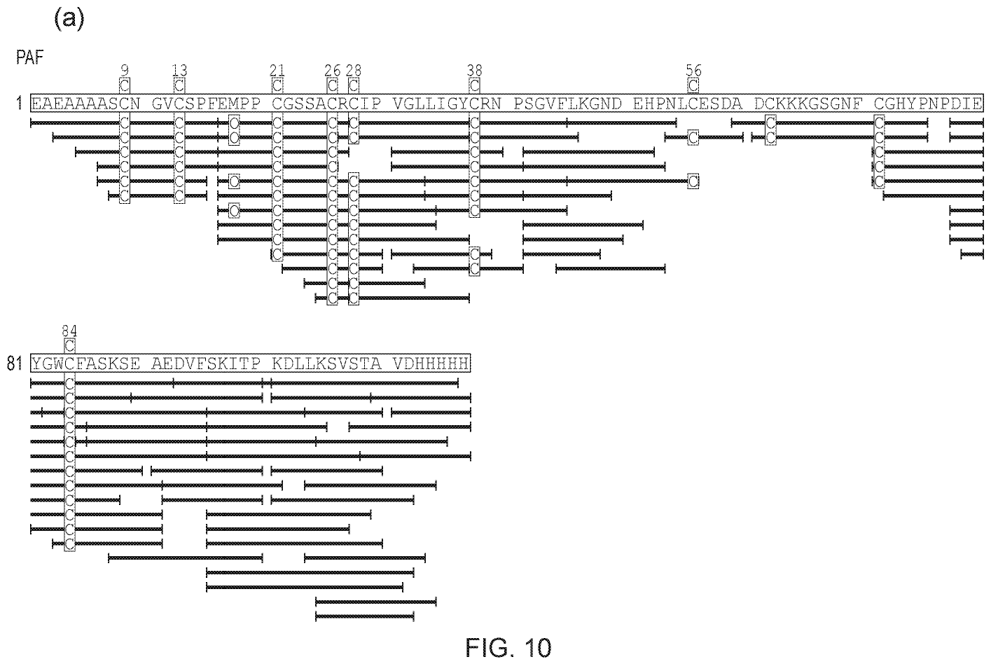

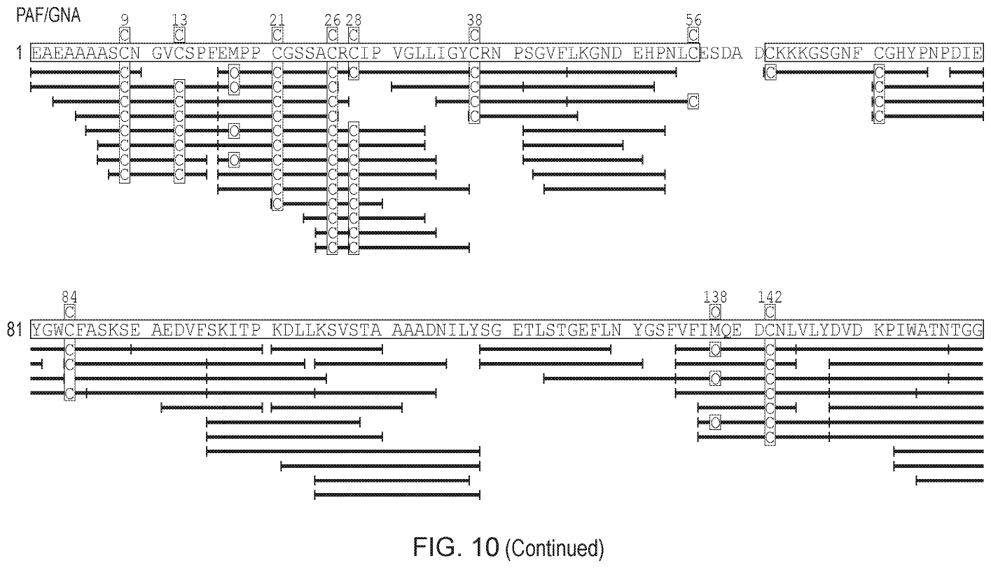

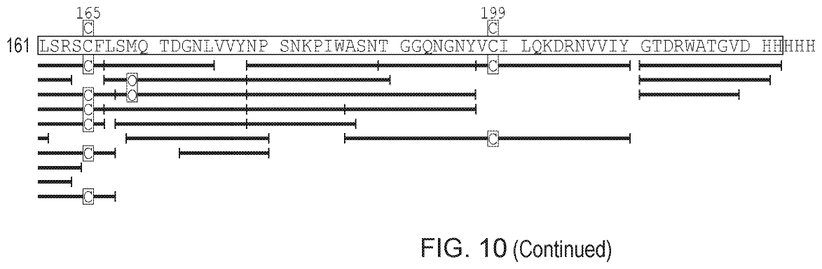

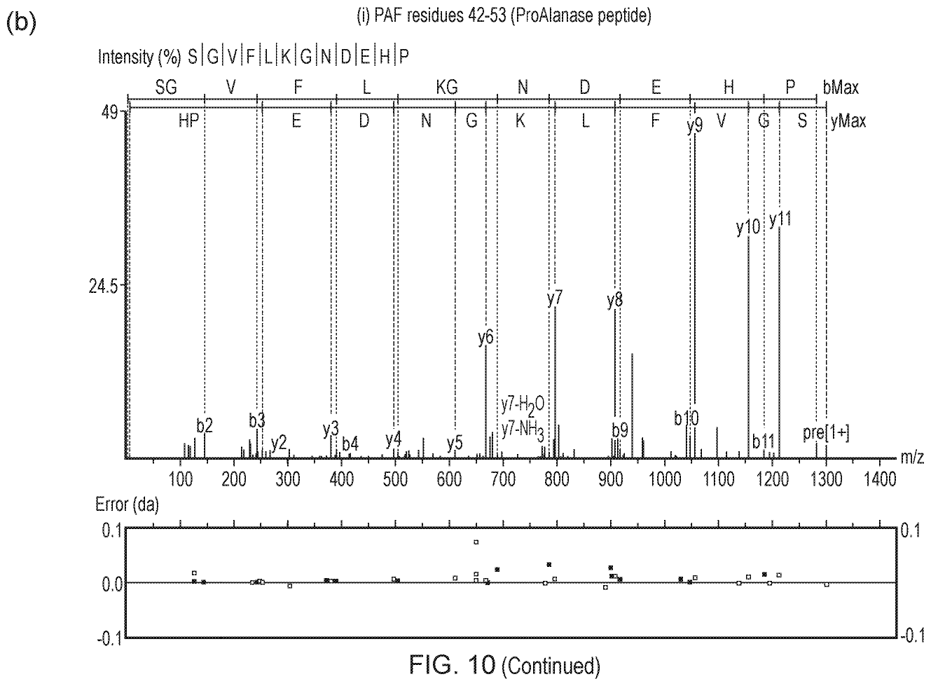

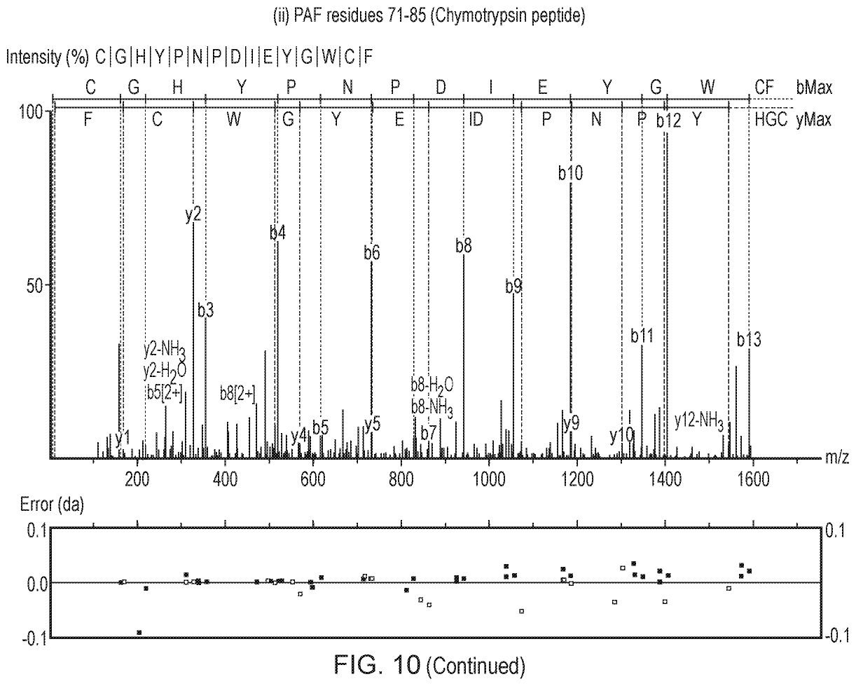

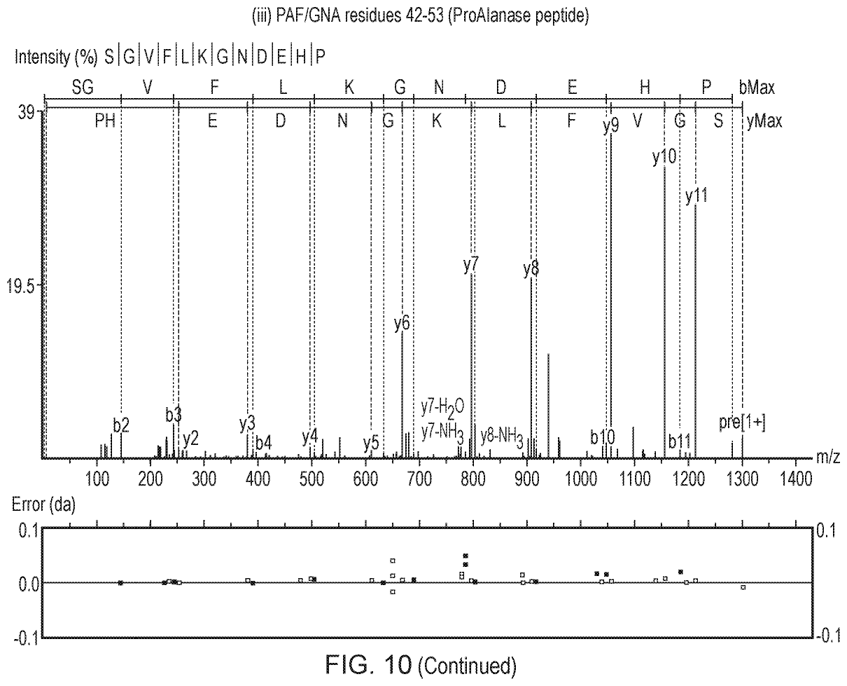

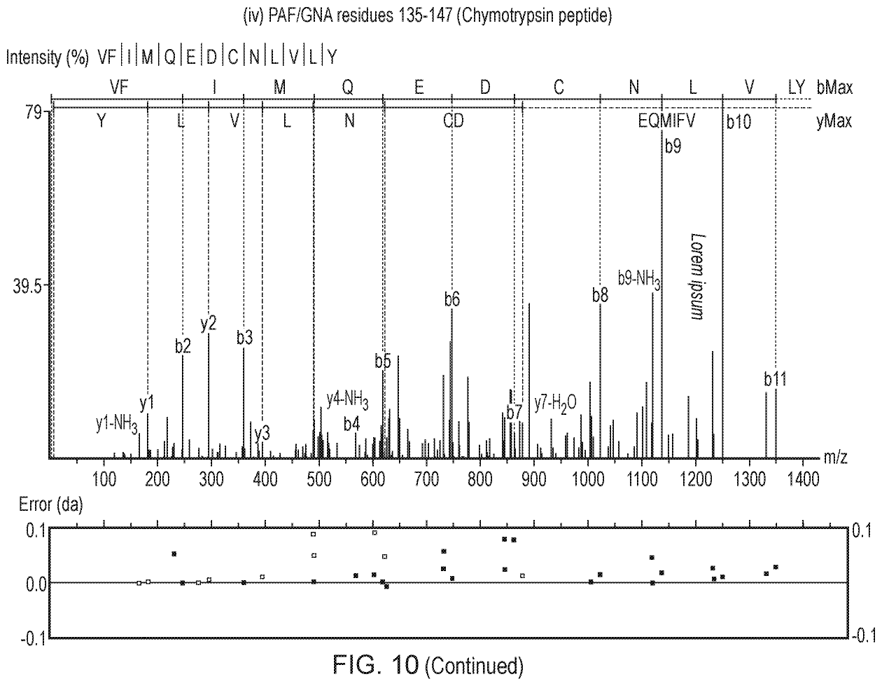

FIG. 10. (a) LC-MS data obtained from ProAlanase and chymotrypsin digests of the PAF and PAF/GNA protein products. The light grey horizontal bars depict identified peptides. Primary structure of recombinant proteins expressed by transformed P. pastoris cells. Additional residues EAEAAA remain in expressed products due to incomplete processing of the alpha factor sequence by yeast dipepti-dyl aminopeptidase, and the additional alanine is a consequence of gene insertion via a Pst/restriction site. Remaining residues are the result of the cloning process for the expression construct. (b) Examples of LC-MS spectra obtained following fragmentation of PAF and PAF/GNA proteins.

### METHODS

### Materials

A P. pastoris codon optimised nucleotide sequence encoding ω/κ-hexatoxin-Hv1h (Accession No. S0F209; residues 38-76) hereafter referred to as HxTx-Hv1h, and cloning primers were purchased from Integrated DNA Technologies (IDT). A P. pastoris codon optimised nucleotide sequence (https://eu.idtdna.com/CodonOpt) encoding PA1 without the signal peptide (NCBI Accession P62930 residues 33-103), hereafter referred to as PAF, and cloning primers were purchased from Integrated DNA Technologies (IDT). Restriction endonucleases were supplied by Thermo scientific or New England BioLabs. Electrophoresed DNA fragments were purified from excised gel slices using a Qiagen gel extraction kit. Plasmid DNA was prepared using Promega Wizard miniprep kits. T4 ligase kit was supplied by Promega. Phusion polymerase was from New England Biolabs. P. pastoris (SMD1168H strain), the expression vector pGAPZαB and Easy comp Pichia transformation kit were from Invitrogen.

Anti-GNA antibodies were prepared by Genosys Biotechnologies, Cambridge, UK. Monoclonal 6x-His Tag Antibodies were from Fisher Scientific, UK. Secondary IgG horseradish peroxidase antibodies were from Biorad. Chemicals for chemiluminescence and buffer salts were supplied by Sigma.

### Assembly of HxTx-Hv1h and HxTx-Hv1h/GNA Fusion Protein Expression Constructs

The HxTx-Hv1h coding sequence was amplified by PCR using primers containing PstI and Sa/I restriction sites. Following gel purification, the PCR product was digested (PstI and Sa/I) and ligated into similarly cut vector, pGAPZαB DNA. To generate a fusion protein construct where HxTx-Hv1h is linked to the N-terminus of GNA, the toxin coding sequence (FIG. 1a) was amplified by PCR (using primers containing PstI and NotI restriction sites), gel purified, restricted, and ligated into a previously generated pGAPZαB construct that contained a GNA coding sequence. Plasmids were cloned into electrocompetent E. coli (DH5α) cells and DNA coding sequences were verified by “in house” DNA sequencing.

### Assembly of PAF and PAF/GNA Fusion Protein Expression Constructs

The PAF coding sequence was amplified by PCR using primers containing PstI and Sa/I restriction sites. Following gel purification, the PCR product was digested (PstI and Sa/I) and ligated into similarly cut vector, pGAPZαB DNA. To generate a fusion protein construct where PAF is linked to the N-terminus of GNA, the toxin coding sequence (FIG. 8a) was amplified by PCR (using primers containing PstI and NotI restriction sites), gel purified, restricted, and ligated into a previously generated pGAPZαB construct that contained a GNA coding sequence. Plasmids were cloned into electrocompetent E. coli (DH5α) cells and DNA coding sequences were verified by “in house” DNA sequencing and analysed using Serial Cloner 2.6.

### Yeast Transformation, Expression and Purification of Recombinant Proteins

DNAs from sequence verified clones were linearised with AvrII and transformed into chemically competent P. pastoris cells according to the manufacturer's instructions. Transformants were selected on medium containing 100 μg/ml zeocin. Clones expressing recombinant HxTx-Hv1h or HxTx-Hv1h/GNA or PAF or PAF/GNA were selected for production by bench-top fermentation by Western analysis (using anti-His or anti-GNA antibodies) of supernatants from 10 mL cultures grown at 30° C. for 2-3 days in YPG medium (1% [w/v] yeast extract, 2% [w/v] peptone, 4% [v/v] glycerol, 100 μg/mL zeocin) (results not shown).

For protein production P. pastoris cells expressing HxTx-Hv1h or HxTx-Hv1h/GNA or GNA or PAF or PAF/GNA were grown in a bench top fermenter (ez-control Applikon 7.5 L vessel) as previously described (Fitches et al. 2012). Following fermentation, proteins were separated from cells by centrifugation (20 min at 7000 g, 4° C.) and purified via nickel affinity chromatography as previously described in the art. Pooled fractions containing purified proteins were dialysed against dist. water and lyophilised. Protein contents in lyophilised samples were determined from SDS-PAGE gels stained for total proteins with Coomassie blue. Quantitation was based on bands corresponding to intact proteins, which were compared to GNA (Sigma) standards by visual inspection, and iBright analysis of gel images scanned using a commercial flat-bed scanner.

### Electrophoresis, Western Blotting and Fluorescein Conjugation

SDS-PAGE electrophoresis, western blotting and fluorescein isothiocyanate (FITC) labelling of recombinant proteins was carried out as described previously (Fitches et al. 2012).

### Recombinant Protein Characterization

Recombinant HxTx-Hv1h and HxTx-Hv1h/GNA were separated by SDS-PAGE and excised bands from gels stained with Coomassie Blue were analysed by LC-MS. Recombinant PAF and PAF/GNA were separated by SDS-PAGE and excised bands from gels stained with Coomassie Blue were analysed by LC-MS. Proteins in excised bands were digested with chymotrypsin or ProAlanase and/or trypsin and LC-MS analysis was performed with a Sciex TripleTOF 6600 mass spectrometer coupled to an ekspert™ nanoLC 425 with low micro-gradient flow module (Eksigent) via a DuoSpray source (Sciex) as described previously in the art.

### Insect Rearing

Acyrthosiphon pisum (pea aphid) and Myzus persicae (peach potato aphid) were reared on broad bean (Vicia faba) and Chinese cabbage (Brassica rapa), respectively, and both colonies were maintained at 22° C. with a 16 h light: 8 h dark cycle.

### Aphid Feeding and Choice Assays

Oral toxicity to A. pisum and M. persicae was determined using cylindrical feeding chambers overlain with parafilm sandwiches that contained proteins dissolved in liquid artificial diet (Prosser & Douglas, 1992). Stock proteins solutions in sodium phosphate buffer (50 mM pH 7.4; SPB) were added to sterile diet such that 100 L diet contained 25 μL protein solution. Control diets contained an equivalent volume of SPB to the protein treatments. One day-old nymphs, selected from adults maintained on artificial diet for 24 h, were placed on 25 μL artificial diet (15 nymphs per dose). Diets were replaced every 2 days and survival recorded daily. Preliminary assays enabled determination of appropriate ranges of protein concentrations to allow derivation of median lethal concentrations.

Choice assays were performed similarly to oral toxicity bioassays except that 25 μL of diet containing 0.6 mg/mL of a given test protein was placed alongside 25 μL control diet between 2 layers of parafilm on a feeding chamber such that the diets did not mix. Ovalbumin was used as a control protein treatment. Twenty day 1 nymphs were placed between two diets (3 replicates per choice test) and the number of aphids feeding on each diet was recorded after 24 h and 48 h.

### Aphid (A. pisum) Topical Assays

A topical protein delivery method was developed based upon procedures described by Niu et al. (2019) except that adult pea aphids were temporarily immobilised using CO₂ and proteins were re-suspended in water containing 0.1% (v/v) Breakthru. Anaesthetised aphids were individually placed in ventral contact with a 0.5 μL droplet of protein solution, left for 12 mins, and then placed in feeding chambers. Unlike Nui et al. (2019) the droplets did not completely dry and so not all of the protein was adsorbed to the aphid cuticle. Preliminary experiments identified suitable protein concentrations and the appropriate adjuvant. 3-12 biological replicates (15 aphids per replicate) were conducted for each protein treatment and dose; survival was recorded 24 h post treatment. Western analysis was performed on protein extracts of whole aphids that had been topically treated and then fed on control diet for 2 and 18 h as follows; aphids (10 per sample) were washed with 20% EtOH, ground with a micropestle in the presence of 100 μL 5× SDS-sample buffer (containing 10% [v/v] β-mercaptoethanol), boiled for 10 min, and centrifuged prior to loading 30 μL per lane on gel.

### Fluorescent Microscopy

Pea aphids were fed on FITC labelled proteins in diet (HxTx-Hv1h 0.25 mg/mL, GNA 0.75 mg/mL, HxTx-Hv1h/GNA 1 mg/mL) for 24 h and then transferred to control diet for a chase period of up to 24 h. Controls were fed on diet containing FITC and 0.1 mg/ml propidium iodide (PI) to enable visualisation of the gut. A subset of aphids (6 per treatment) fed on labelled proteins were retained as individuals in feeding chambers to allow emerging nymphs to be visualised. For contact assays, aphids were “dipped” in labelled protein solutions as described previously and placed on control diets for up to 18 h. Prior to visualisation, aphids were washed to remove non-penetrating proteins by immersion in 20% EtOH. Aphids (9-12 per treatment and time point) were visualized using a fluorescent microscope (Leica MC165) under FITC filter (absorbance 494 nm; emission 521 nm) and images captured in OpenLab.

### Examples

### Recombinant protein production in the yeast P. pastoris

Synthetic genes encoding HxTx-Hv1h and HxTx-Hv1h/GNA were cloned in frame with the yeast alpha factor in the expression vector pGAPZαB by PCR amplification, followed by restriction and ligation. A fusion protein was generated by fusing the HxTx-Hv1h protein to the N-terminus of GNA via an 8 amino acid residue, (GGGGSAAA) linker region as depicted in FIG. 1a. Both constructs contain a six-residue histidine tag at the C-terminus to enable affinity purification, and 2 additional N-terminal residues, glycine and serine (GS) reported to enhance the expression levels of HxTx-Hv1h in the yeast P. pastoris (WO 2013/134734 A2). Constructs were cloned into E. coli and sequenced plasmid DNAs were linearised and transformed into competent P. pastoris cells. Small scale screening by western blotting for protein expression enabled the selection of clones for bench-top fermentation to produce sufficient quantities of proteins for insect bioassays. P. pastoris cells were grown in a laboratory fermenter and all recombinant proteins expressed at levels of more than 30 mg/L in culture supernatants. Proteins were purified from clarified supernatants by nickel-affinity chromatography, followed by dialysis and freeze drying.

As shown in FIG. 1b, purified recombinant HxTx-Hv1h separates as 2 protein products of approximately 17 kDa on SDS-PAGE gels, which is more than double the predicted mass of 7 kDa. Immunoreactivity with anti-His antibodies (FIG. 1c) provides evidence that both proteins represent recombinant toxin and LC-MS analysis further confirmed that both proteins are full length and have identical sequence. The higher than predicted mass for recombinant HxTx-Hv1h protein products is thought to be, at least in part, due to hyperglycosylation which is commonly observed during expression of recombinant proteins in P. pastoris. Purified HxTx-Hv1h/GNA stained as a single protein of approximately 20 kDa on SDS-PAGE gels (2 kDa higher than its predicted molecular mass; FIG. 1b) and reacted positively with anti-GNA and anti-His antibodies (FIG. 1c). LC-MS analysis confirmed the presence of full-length sequence and that both proteins contain an additional alanine as a consequence of gene insertion via a PstI restriction site in the pGAPZαB vector. Recombinant GNA which contains a C-terminal histidine tag runs at approximately 14 kDa on SDS-PAGE gel (FIG. 1b), close to its predicted molecular mass of 12.8 kDa. The functionality of the GNA component of the recombinant fusion protein was confirmed by in vitro agglutination assays (results not shown).

Synthetic genes encoding PAF and PAF/GNA were cloned in frame with the yeast alpha factor in the expression vector pGAPZαB by PCR amplification, followed by restriction and ligation. A fusion protein was generated by fusing the full length PAF protein to the N-terminus of GNA via a 3 amino acid residue, (Ala-Ala-Ala) linker region as depicted in FIG. 8a. Both constructs contain a six-residue histidine tag at the C-terminus to enable immunoblot detection and affinity purification. Constructs were cloned into E. coli and sequenced plasmid DNAs were linearised and transformed into competent P. pastoris cells. Small scale screening by western blotting for protein expression enabled the selection of clones for bench-top fermentation to produce sufficient protein for insect bioassays. P. pastoris cells were grown in a laboratory fermenter and recombinant proteins were purified from clarified supernatants by nickel-affinity chromatography, followed by dialysis and freeze drying. PAF and PAF/GNA were expressed at respective levels of ca. 40 and 80 mg/L culture supernatant.

As shown in FIG. 8b, purified recombinant PAF separates as 2 protein products of approximately 14 kDa on SDS-PAGE gels which is close to the predicted mass of 12.7 kDa. Immunoreactivity with anti-His antibodies (FIG. 8c) provides evidence that both proteins represent recombinant PAF. Staining of PAF by periodic acid Schiff blot analysis confirmed glycosylation of recombinant PAF (but not PAF/GNA) and thus differential glycosylation may account for the presence of 2 protein products (results not shown). LC-MS analysis of PAF confirmed that both proteins are full length, comprised of both the PA1b and PA1a peptides, have identical sequence, and contain additional 5 N-terminal residues (Glu-Ala-Glu-Ala-Ala) due to incomplete processing of the alpha factor sequence by yeast dipeptidyl aminopeptidase, and an additional alanine due to gene insertion via a Pst/restriction site (FIG. 10). Purified PAF/GNA separates as a single protein of approximately 25 kDa on SDS-PAGE gels, similar to the 24.5 kDa predicted mass (FIG. 1a, b) and a minor product of ca. 14 kDa. Both proteins reacted positively with anti-GNA and anti-His antibodies suggesting that the 25 kDa product is intact PAF/GNA and the minor 14 kDa protein is cleaved GNA (FIG. 1c). LC-MS analysis of the 25 kDa protein confirmed the presence of full-length sequence and, as for PAF, the presence of additional N-terminal residues (Online Resource 1). As previously reported recombinant GNA which contains a C-terminal histidine tag runs at approximately 14 kDa on SDS-PAGE gel (FIG. 8b, c), close to its predicted molecular mass of 12.8 kDa (Powell et al. 2019). The functionality of the GNA component of recombinant PAF/GNA was confirmed by in vitro agglutination assays (results not shown).

### Biological Activity of Recombinant Proteins

### Oral Toxicity of Recombinant Proteins to Aphids

Oral toxicity was determined by feeding A. pisum or M. persicae nymphs with artificial diets containing a range of concentrations (0.2-2 mg/ml) of recombinant HxTx-Hv1h, HxTx-Hv1h/GNA or GNA. As shown in FIG. 2 dose dependent reductions in the survival of aphids fed on protein containing diets were observed in all assays whereas control (no added protein diet) survival was >85%. HxTx-Hv1h alone was similarly toxic towards both species with 100% mortality observed after 4 days of feeding on diets containing >0.6 mg/ml of protein and comparable LC₅₀ (Day 2) values of 0.70 mg/mL and 0.68 mg/mL were derived for pea and peach potato aphids, respectively. The HxTx-Hv1h/GNA fusion protein also showed comparable toxicity to both species with respective LC₅₀ (Day 2) values of 0.62 mg/mL and 0.59 mg/mL derived for pea and peach potato aphids. Whilst LC₅₀ values for HxTx-Hv1h/GNA are comparable to HxTx-Hv1h values on a total protein basis, they are ca. 4.5 fold lower on a toxin only basis. Feeding on GNA alone caused a significant reduction in the survival of A. pisum at dietary concentrations of ≥0.6 mg/ml (Log Rank Mantel-Cox; P<0.05) whereas no significant differences in M. persicae survival as compared to control fed aphids were observed for any of the GNA treatments.

In choice assays both aphid species showed a preference for feeding on control (no added protein) diet over each of the recombinant proteins but no preference for the control versus ovalbumin (control non-toxic protein) diets was observed (Online resource 2.) These results suggest that the observed mortality of aphids fed on protein containing diets (FIGS. 2 and 3) is at least, in part, due to anti-feedant effects.

Further aphid bioassays were conducted to verify that the enhanced efficacy of HxTx-Hv1h/GNA was attributable to the direct action of the fusion protein rather than additive effects of feeding a combination of the toxin and GNA. As shown in FIG. 3, 100% mortality of A. pisum or M. persicae was observed after 3 or 4 days after feeding on diets containing 0.6 mg/mL fusion protein, respectively. By comparison, feeding on a combination of equivalent concentrations of HxTx-Hv1h (0.15 mg/mL) and GNA (0.45 mg/mL) resulted in 100% A. pisum and 93% M. persicae mortality after 5 days of feeding. Survival curves for fusion protein and the combination treatments were significantly different (P=0.0101 A. pisum and P=0.016 M. persicae; Mantel-Cox, log-rank test). Combining both toxin and GNA resulted in additive effects upon aphid survival; for example, after 3 days of feeding a respective 27% and 47% pea aphid mortality was observed for HxTx-Hv1h and GNA treatments, as compared to 73% mortality for the treatment containing a mixture of toxin and GNA. That mortality was attributable to ingestion of the protein and not simply to antifeedant effects is indicated by the slower onset of full mortality as compared to the no diet control treatment.

Fluorescence imagery of whole A. pisum chase-fed control diet after feeding on equimolar concentrations of FITC labelled toxin, fusion protein or GNA for 24 h is presented in FIG. 4. Visualisation of the foregut is evident in control PI fed aphids. Labelled proteins were readily detectable in aphids after 24 h of feeding and fluorescence (particularly in the gut region) persisted for a chase-feed period of 6 h suggesting all proteins were all able to bind to the gut epithelium. Fluorescence persisted in GNA and fusion protein fed aphids after 24 h of chase feeding but was notably absent in HxTx-Hv1h fed aphids, suggesting comparatively weaker binding and more rapid clearance of the toxin. Transport of fusion protein across the aphid gut to the circulatory system is indicated by whole body fluorescence in adult aphids and fluorescence of the gut region in progeny derived from HxTx-Hv1h/GNA fed adults. This was not observed for progeny derived from aphids fed HxTx-Hv1h or GNA alone although sample numbers were limited (4-5 nymphs per treatment) as very few aphids produced nymphs.

### Contact Toxicity A. pisum

The efficacy of topically applied proteins was evaluated by placing pea aphids in ventral contact with droplets containing different concentrations of HxTx-Hv1h, HxTx-Hv1h/GNA or GNA (FIG. 5a). Mean survival of aphids exposed to water only control was ca. 80% as compared to 70% and 62% for Break-thru alone (control) or GNA (5 μg), respectively suggesting that neither Breakthru nor GNA had a significant impact upon aphid survival. By contrast, significant dose dependent reductions in aphid survival were observed for all HxTx-Hv1h and fusion protein treatments as compared to the control (+Break-thru) group. On a total protein basis these effects were comparable; contact with droplets containing 5.0 μg of HxTx-Hv1h or HxTx-Hv1h/GNA resulted in a 89% and 91% reduction in mean survival whereas the 1.25 μg treatments reduced aphid survival by 51% and 58%, respectively. When comparing the data on a toxin only basis (5.0 μg fusion protein is comprised of ca. 1.25 μg HxTx-Hv1h and 3.75 μg GNA) the 5 μg fusion protein resulted in significantly (P=0.0031; t-test) higher mortality as compared to the 1.25 μg HxTx-Hv1h treatment. The survival of aphids exposed to 1.25 μg fusion protein was also lower than that recorded for 0.31 μg HxTx-Hv1h although this difference was not significant (P=0.101; t-test). Furthermore, a significant reduction in survival (P=0.013; t-test) was observed between aphids exposed to droplets containing 5.0 μg fusion protein and a combination of GNA (3.75 μg) and HxTx-Hv1h (1.25 μg). These results suggest that fusion to GNA potentiates contact efficacy of HxTx-Hv1h towards aphids.

In an additional experiment, the protein treatments were calculated on a molar basis rather than a weight basis to allow a more accurate comparison of the differences in levels of toxicity between the toxin, fusion protein and GNA (FIG. 5b). Mean survival of aphids exposed to water only control was ca. 80% as compared to 70% for Break-thru alone (BT control) and 62% for GNA (280 pmol). Differences between water control and BT or GNA were not significant suggesting that neither Breakthru nor GNA had a significantly detrimental effects upon aphid survival. Exposure to 70 pmol (0.45 μg) of HxTxHv1h did not cause a significant reduction in survival as compared to the BT control treatment. By contrast, significant dose dependent reductions in aphid survival were observed for HxTx-Hv1h (at 280 pmol [1.8 μg] and 800 pmol [5.0 μg]) and fusion protein treatments (70 pmol [1.25 μg] and 280 pmol [5.0 μg]) as compared to the BT control group. Significant differences between survival of fusion protein and toxin only treated aphids were observed for both 70 pmol and 280 pmol treatments (respectively, P=0.0061 and 0.0029, t-tests). Furthermore, a significant reduction in survival was observed between aphids exposed to droplets containing 280 pmol of fusion protein or a combination of 280 pmol each of GNA (280 pmol=3.55 μg) and HxTx-Hv1h (280 pmol=1.8 μg) (P=0.0158; t-test). These results provide evidence that fusion to GNA significantly enhances contact efficacy of HxTx-Hv1h towards aphids.

Delivery of proteins across the cuticle following contact exposure to labelled proteins is shown in FIG. 5c. After “dipping” in protein solutions, aphids were fed on control diet for 18 h, washed and imaged. An absence of fluorescence in control treated aphids contrasts whole body fluorescence observed in GNA, HxTx-Hv1h and fusion protein treated aphids and provides evidence for protein delivery across the cuticle. The intensity of fluorescence appeared generally greater in fusion protein and GNA dipped aphids as compared to HxTx-Hv1h. HxTx-Hv1h was detected by western analysis (FIG. 5d) of whole aphid protein extracts prepared 2 and 4 h after contact exposure but was not detectable in samples prepared 18 h post treatment. By contrast, GNA and HxTx-Hv1h/GNA were both detected in immunoblotted extracts prepared 2 h and 18 h post contact treatment. Whilst all samples were probed with anti-His antibodies it is possible that the histidine tag was cleaved from HxTx-Hv1h treated aphids but remained intact in GNA and fusion protein treated insects.

### Recombinant Protein Production (Hv1a Containing Fusion Proteins) in the Yeast P. pastoris

As shown in FIG. 6b, purified recombinant Hv1a/GNA/His separates as 2 protein products on SDS-PAGE gels as described previously by Powell et al., 2019. Purified His/GNA/Hv1a(k-q) also separates as 2 protein products of approx. 17 and 18 kDa, similar to the predicted mass of 16.95 kDa; both products have been shown by LC-MS analysis to be intact fusion protein and the small difference in mass is thought to be attributable to differences in the degree of glycosylation during expression in P. pastoris cells. k-q mutation enhances expression of intact FP, which is described in WO 2012/131302.

### Topical Assays

The efficacy of topically applied proteins was evaluated by placing pea aphids in ventral contact with droplets containing different concentrations of Hv1a, GNA/Hv1a(k-q) or Hv1a/GNA (FIG. 7). Mean survival of aphids 24 hr after exposure to control treatment (water and Break-thru [BT]) was 76%. For aphids treated with protein containing solutions reductions in survival of protein treatments were significantly reduced as compared to the control treatment (t-test; P<0.02). Dose dependent reductions in survival were observed for Hv1a alone (0.31 μg and 1.25 μg), and fusion proteins GNA/Hv1a(k-q) or Hv1a/GNA at doses of 1.25 μg and 5 μg. Higher mortality was observed for aphids exposed to Hv1a containing fusion proteins as compared to equivalent concentrations of toxin alone (1.25 μg of fusion protein contains 0.31 μg toxin and 5.0 μg of fusion protein contains 1.25 μg toxin). These differences were significant for GNA/Hv1a(k-q) at 5.0 μg and Hv1a at 1.25 μg (t-test: P<0.0001); GNA/Hv1a(k-q) 1.25 and Hv1a at 0.31 μg (t-test: P=0.042); Hv1a/GNA at 1.25 μg and Hv1a at 0.31 μg (t-test; P=0.29). We previously demonstrated that treatment with 5 μg of GNA alone (+BT) did not result in a significant reduction in survival as compared to the control (+BT) treatment (FIG. 5). These results suggest that fusion of the Hv1a toxin to either terminus of GNA results in enhanced contact efficacy of the Hv1a toxin towards aphids.

The efficacy of topically applied PAF, PAF/GNA was evaluated as above; ovalbumin was included as a control protein treatment. As shown in FIG. 9, the mean survival of aphids 24 hours after exposure to either Break-thru alone (BT control) was more than 80% and was 75% for the ovalbumin control protein treatment. Survival following exposure to GNA or lower doses of PAF (50 and 200 pmol) was lower than the control treatments but not significantly. Exposure to the highest PAF concentration (400 pmol) caused a significant decline in survival as compared to the control as did the combination treatment (200 pmol of GNA and 200 pmol PAF); this suggests PAF does have contact activity, albeit at high doses, and that the effects of GNA and PAF are additive. By contrast, significant differences in survival as compared to the control were observed for both PAF/GNA treatments (50 and 200 pmol).

That the fusion protein is significantly more toxic as compared to PAF alone is shown by significant differences between the survival of PAF/GNA and PAF treated aphids observed for both 50 and 200 pmol treatments (respectively, P=0.002 and P=0.0023; t-tests). Furthermore, the mortality of aphids exposed to 200 pmol and 50 pmol fusion protein was also found to be significantly greater than aphids treated with 400 pmol PAF. That efficacy is enhanced as a result of fusion of the two components in the recombinant PAF/GNA, rather than additive effects of the individual components is evidenced by the significantly greater mortality of aphids exposed to 200 pmol of PAF/GNA as compared to an equivalent mixture of 200 pmol each of PAF and GNA (P=0.0029; t-tests). These results provide evidence that fusion of PAF to GNA significantly enhances contact efficacy of the pea albumin protein towards A. pisum.

### Conclusions

The inventors have demonstrated that a recombinant HxTx-Hv1h venom derived neurotoxin, in addition to oral activity, has contact activity against aphid pests. However, whilst toxic in its own right, the inventors demonstrate that fusion of HxTx-Hv1h or Hv1a to a further protein, such as GNA potentiates contact efficacy towards aphids. By analogy, the Vestaron Spear®-Lep product is recommended for use in combination with a low dose of BtK (Bt var. kurstaki) that due to its ability to form pores in the midgut of certain pests enhances delivery of the HxTx-Hv1h toxin to the CNS. Furthermore, the inventors have demonstrated that a recombinant pea albumin protein also has contact activity that is significantly enhanced when fused to GNA. Thus a fusion protein based approach delivered through contact administration may offer an alternative route of administration or an opportunity to further enhance efficacy of toxins, such as HxTx-Hv1h or Hv1a, or PAF (pea albumin) towards pests including those that are resistant to the effects of Bt toxins.

### REFERENCES

Atkinson R K, Vonarx E J, Howden M E H (1996) Effects of whole venom and venom fractions from several Australian spiders, including Atrax (Hadronyche) species, when injected into insects. Comp. Biochem. Physiol. 114C, 113±117.
Bonning B C, Pal N, Li, S, Wang Z, Sivakumar S, Dixon P M, King G F, Miller W A (2014) Toxin delivery by the coat protein of an aphid-vectored plant virus provides plant resistance to aphids. Nature Biotechnology 32 (1): 102-105. https://doi: 10.1038/nbt.2753.
Chambers C, Cutler P, Huang Y-H, Goodchild J A, Blythe J, Wang C K, Bigot A, Kaas Q, Craik D J, Sabbadin D, Earley F G (2019). Insecticidal spider toxins are high affinity positive allosteric modulators of the nicotinic acetylcholine receptor. FEBS Letters 593:1336-1350. https://doi: 10.1002/1873-3468.13435.
Chong Y, Hayes J L, Sollod B L, Wen S, Hains P G (2007) The omega-atracotoxins: selective blockers of insect M-LVA and HVA calcium channels. Biochemical Pharmacology 74:623-638. https://10.1016/j.bcp.2007.05.017.
Craik D J, Daly N L, Waine C (2001) The cystine knot motif in toxins and implications for drug design. Toxicon 39 (1), 43-60. https://doi.10.1016/s0041-0101 (00) 00160-4.
Fletcher J I, Smith R, O'Donoghue S I, Nilges M, Connor M, Howden, M E (1997) The structure of a novel insecticidal neurotoxin, v-atracotoxin-HV1, from the venom of an Australian funnel web spider. Nature Structural Biology 4:559-66. https://10.1038/nsb0797-559.
Fitches E, Edwards M G, Mee C, Grishin E, Gatehouse A M R, Edwards J P, Gatehouse J A (2004) Fusion proteins containing insect-specific toxins as pest control agents: snowdrop lectin delivers fused insecticidal spider venom toxin to insect haemolymph following oral ingestion. Journal of Insect Physiology 50:61-71. doi: 10.1016/j.jinsphys.2003.09.010.
Fitches E C, Bell H A, Powell M E, Back E, Sargiotti C, Weaver R J, Gatehouse J A (2010) Insecticidal activity of scorpion toxin (ButaIT) and snowdrop lectin (GNA) containing fusion proteins towards pest species of different orders. Pest Manag Sci 66(1): 74-84. https://doi.org/10.1002/ps. 1833.
Fitches E C, Pyati P S, King G F, Gatehouse J A (2012) Fusion to snowdrop lectin dramatically enhances the oral activity of the insecticidal peptide w-hexatoxin-Hv1a by mediating its delivery to the central nervous system. PloS One 7: e39389.
Herzig V, de Araujo A D, Greenwood K P, Chin Y K, Windley M J, Chong Y, Muttenthaler M, Mobli M, Audsley N, Nicholson G M, Alewood P F, King G F (2018) Evaluation of chemical strategies for improving the stability and oral toxicity of insecticidal peptides. Biomedicines 6:90-105. https://doi: 10.3390/biomedicines6030090.
King G F, Hardy M C (2013) Spider-venom peptides: Structure, pharmacology, and potential for control of insect pests. Annual Review of Entomology. 58:475-496. https://doi.org/10.1146/annurev-ento-120811-153650.
Niu J, Yang W-J, Tian Y, Fan J-Y, Ye C, Shang F, Ding B-Y, Zhang J, An X, Yang L, Chang T-Y, Christiaens O, Smagghe G, Wang J-J (2019) Topical dsRNA delivery induces gene silencing and mortality in the pea aphid. Pest Manag Sci 2019; 75:2873-2881. https://doi. 10.1002/ps.5457.
Pallagh P K, Nielsen K J, Craik D J, Norton R S (1994) A common structural motif incorporating a cystine knot and a triple-stranded B-sheet in toxic and inhibitory polypeptides. Protein Sci. 3, 1833-1839 (1994). https://doi.10.1002/pro.5560031022
Pineda S S, Chaumeil P A, Kunert A, Kaas Q, Thang, M W C, Le L, Nuhn M, Herzig V, Saez N J, Cristofori-Armstrong B, Anangi R, Senff S, Gorse D, King G F (2018) ArachnoServer 3.0: an online resource for automated discovery, analysis and annotation of spider toxins. Bioinformatics 34, 1074-1076.
Powell, M. E., Bradish, H. M., Cao, M., Makinson, R., Brown, A. P., Gatehouse, J. A. and Fitches, E. C., 2020. Demonstrating the potential of a novel spider venom-based biopesticide for target-specific control of the small hive beetle, a serious pest of the European honeybee. Journal of pest science, 93(1), pp.391-402.
Saez N J, Herzig V (2019) Versatile spider venom peptides and their medical and agricultural applications. Toxicon, 158:109-126. doi: https://doi.org/10.1016/j.toxicon.2018.11.298.
Tedford H W, Gilles N, Menez A, Doering C J, Zamponi G W, King G F (2004) Scanning mutagenesis of v-atracotoxin-Hv1a reveals a spatially restricted epitope that confers selective activity against insect calcium channels. Journal of Biological Chemistry 279:44133-40. https://doi: 10.1074/jbc.M404006200.

1. A method of controlling a plant pest or a pest of bees, the method comprising administering by contact/topical administration to the pest, a pesticide formulation, which comprises at least one pesticidal recombinant toxin fusion protein, or fragment, or variant thereof.

2-3. (canceled)

4. The method according to claim 31, wherein the pest of bees is a small hive beetle or a parasitic mite.

5. The method according to claim 1, wherein said at least one pesticidal recombinant toxin fusion protein, or fragment, or variant thereof is fused to a carbohydrate binding module.

6. The method according to claim 1, wherein said at least one pesticidal recombinant toxin fusion protein, or fragment, or variant thereof, comprises an ICK motif containing protein, or a fragment or variant thereof.

7. The method according to claim 1, wherein the pesticidal recombinant toxin fusion protein, or fragment or variant thereof, comprises an arachnid-derived toxin, or fragment or variant thereof or an insect-derived toxin, or fragment or variant thereof.

8. The method according to claim 7, wherein the arachnid-derived toxin is a spider toxin, or fragment or variant thereof.

9. The method according to claim 8, wherein the spider toxin is a hexatoxin.

10. The method according to claim 9, wherein the hexatoxin is HxTx-Hv1h, Hv1a or a variant or fragment thereof.

11. The method according to claim 6, wherein the ICK motif containing protein comprises a pea albumin, or a fragment or variant thereof.

12. The method according to claim 6, wherein the ICK motif containing protein comprises PAF, or fragment, or variant thereof.

13. The method according to claim 5, wherein the carbohydrate binding module comprises a lectin.

14. The method according to claim 13, wherein the lectin comprises a mannose-binding lectin.

15. The method according to claim 13, wherein the lectin comprises a snowdrop lectin (GNA).

16. The method according to claim 1, wherein the pesticidal recombinant toxin fusion protein further comprises a linker sequence between the toxin protein and the carbohydrate binding module.

17. The method according to claim 16, wherein the linker sequence comprises the sequence (G)nS(A)n, (G)n, (GGGGS)n, where n is 2 to 6.

18. The method according to claim 1, wherein the pesticidal recombinant toxin fusion protein, or fragment or variant thereof, is fused to the N-terminus or C-terminus of the carbohydrate binding module.

19. The method according to claim 1, wherein the pesticidal recombinant toxin fusion protein comprises any one or more proteins selected from SEQ ID NO:6 to SEQ ID NO:13 or SEQ ID NO:7 to SEQ ID NO:13.

20. (canceled)

21. The method according to claim 1, wherein the pesticidal recombinant toxin fusion protein comprises SEQ ID NO: 15.

22. The method according to claim 1, wherein the pesticide formulation further comprises one or more excipients, carriers, and/or adjuvants.

23. The method according to claim 22, wherein the excipient of the pesticide formulation comprises one or more surfactants.

24. The method according to claim 23, wherein the one or more surfactants comprise non-ionic spreading and penetration surfactant and/or non-ionic organosilicone surfactant.

25. The method according to claim 22, wherein the pesticide formulation further comprises a pest attractant and/or a sticky substance for facilitating adherence of the pesticide formulation to the outer surface of the pest.

26. A chemical composition comprising a pesticidal recombinant toxin fusion protein, wherein the pesticidal recombinant toxin fusion protein comprises a linker sequence between a toxin protein and a carbohydrate binding module, wherein the chemical composition is formulated with one or more excipients, carriers, and/or adjuvants for agricultural use, and wherein the chemical formulation further comprises a pest attractant and/or a sticky substance for facilitating adherence of the pesticide formulation to the outer surface of the pest.

27. The chemical composition according to claim 26, wherein the excipient of the pesticide formulation comprises one or more surfactants.

28. The chemical composition according to claim 27, wherein the one or more surfactants comprise non-ionic spreading and penetration surfactant and/or non-ionic organosilicone surfactant.
